(19) United States
(12) Patent Application Publication
(10) Pub. No.: US 2021/0354710 A1
(43) Pub. Date: Nov. 18, 2021

(54) EXECUTION MONITORING DEVICE AND EXECUTION MONITORING METHOD

(71) Applicant: MITSUBISHI ELECTRIC CORPORATION, Tokyo (JP)

(72) Inventors: Yuta WADA, Tokyo (JP); Naoki UEDA, Tokyo (JP); Yuta ATOBE, Tokyo (JP); Yosuke YOKOYAMA, Tokyo (JP); Yukio IZUMI, Tokyo (JP)

(73) Assignee: MITSUBISHI ELECTRIC CORPORATION, Tokyo (JP)

(21) Appl. No.: 17/387,353

(22) Filed: Jul. 28, 2021

Related U.S. Application Data
(63) Continuation of application No. PCT/JP2020/015547, filed on Apr. 6, 2020.

(30) Foreign Application Priority Data
Apr. 12, 2019 (JP) PCT/JP2019/016058

(51) Int. Cl. B60W 50/06; B60W 50/04; G07C 5/12

(52) U.S. Cl. CPC B60W 50/06; B60W 2050/0088; G07C 5/12; B60W 50/045

(57) ABSTRACT

A execution monitoring device (20) includes a time-series data storage unit (225) to store time-series data and a real-time specification determining unit (204). The real-time specification determining unit (204) updates a determination result, which is a result of determining whether the time-series data stored in the time-series data storage unit (225) satisfies a real-time specification, which is part of constraints included in a monitoring specification for electronic device runtime monitoring, is stored in a memory area reserved before execution of the real-time specification determining unit (204), and is a constraint using a real time.

### CROSS-REFERENCE TO RELATED APPLICATION

This application is a Continuation of PCT International Application No. PCT/JP2020/015547 filed on Apr. 6, 2020, which claims priority under 35 U.S.C. § 119(a) to Patent Application No. PCT/JP2019/016058 filed in Japan on Apr. 12, 2019, all of which are hereby expressly incorporated by reference into the present application.

### TECHNICAL FIELD

The present invention relates to an execution monitoring device for an electronic device.

### BACKGROUND ART

In an embedded system such as an in-vehicle systems, it is required to add and update functions, apply a security patch, support new legal regulations, and so forth. Thus, system complication, reduction in market lead time, and so forth are required, thereby posing a problem in which prior inspection of the embedded system is becoming even more difficult. Moreover, there is a problem in which introduction of AI (Artificial Intelligence) into the embedded system has been increased, making encompassing inspection more difficult.

To address these problems, runtime monitoring technology has been suggested. Runtime monitoring is a technique of monitoring whether the behavior of the embedded system deviates from a predetermined specification, precondition, and so forth (hereinafter, the predetermined specification, precondition, and so forth are simply referred to a monitoring specification). By monitoring whether the behavior of the embedded system deviates from the monitoring specification, this can take as a trigger for causing the vehicle to make a transition to a safe state, and that deviation can be fed back to a developer to promote improvement and can be used as a test oracle at the time of development.

As one technique usable for runtime monitoring technology, for example, Patent Literature 1 discloses a rule base system in which working memory exhaustion is prevented and garbage collection is not required to act. In this technique, the working memory is statically allocated to each of a plurality of condition items to prevent working memory exhaustion.

Also, in Non-Patent Literature 1, a time-extended Rete algorithm is suggested.

The Rete algorithm is a rule determination algorithm suggested in 1975, and has been adopted in rule management engines for business (such as OPS5, CLIPS, and Drools). While having an advantage in which not all rules are evaluated every time an event is inserted, the Rete algorithm is basically oriented for enterprise systems and has problems in which the resource use amount is large and dynamic memory allocation is required.

In Non-Patent Literature 1, by using a garbage collector which dynamically deletes an event if that event has ceased to contribute to a real-time constraint, extension is made so that the real-time constraint can be monitored by the Rete algorithm.

### CITATION LIST

### Patent Literature

Patent Literature 1: JP 2018-132796 A

### Non-Patent Literature

Non-Patent Literature 1: K. Walzer, T. Breddin, and M. Groch, “Relative temporal constraints in the Rete algorithm for complex event detection,” presented at the Proceedings of the second international conference on Distributed event-based systems, Rome, Italy, 2008.
Non-Patent Literature 2: A. Kane, “Runtime monitoring for safety-critical embedded systems,” 2015.
Non-Patent Literature 3: O. Maier, D. Nickovic, and A. Pnueli, “On Synthesizing Controllers from Bounded-Response Properties,” in Computer Aided Verification, Berlin, Heidelberg, 2007, pp. 95-107: Springer Berlin Heidelberg.
Non-Patent Literature 4: R. L. Rudell and A. Sangiovanni-Vincentelli, “Multiple-Valued Minimization for PLA Optimization,” in IEEE Transactions on Computer-Aided Design of Integrated Circuits and Systems, vol. 6, no. 5, pp. 727-750, September 1987.

### SUMMARY OF INVENTION

### Technical Problem

Meanwhile, some monitoring specifications to be monitored in the embedded system include a real-time constraint, and others do not.

Description is made by taking, as an example, an ACC (Adaptive Cruise Control) system which follows a forward vehicle if present and sets a constant speed of an automobile if no forward vehicle is present. Note that this example is the one obtained by partially modifying the system described in Non-Patent Literature 2.

In the ACC system, as an example of a monitoring specification not including a real-time constraint, “if the ACC valid signal is True, the service ACC signal (error signal) is False” can be cited. This specification is a monitoring specification in which it is intended that ACC does not become valid if the ACC function has an anomaly.

In the ACC system, as an example of a monitoring specification including a real-time constraint, “if the ACC valid signal is True and the following distance time is shorter than one second, it is required to recover to be equal to or longer than 1.0 second within five seconds” can be cited. This specification is a monitoring specification in which it is intended that the following distance is quickly allocated if the own vehicle becomes too close to the forward vehicle.

As being introduced into the embedded system, the runtime monitoring technology is required to be resource-saving, and is also required to support a monitoring specification with mixed real-time constraints. Moreover, since the embedded system normally has a plurality of functions, the runtime monitoring technology is required to efficiently determine many monitoring specifications.

In the specifications described above as a specific example, portions “if the ACC valid signal is True” are common, and these can be commonly used for determination.

However, a technique of efficiently determining the monitoring specification including the real-time constraint in the embedded system is not disclosed in the prior technology literatures. The technology disclosed in Patent Literature 1 does not support a real-time constraint, and efficiently determining many monitoring specifications is not considered. The technology disclosed in Non-Patent Literature 1 adopts dynamic memory allocation, and is thus not suitable for embedded systems. Therefore, the above-described problems cannot be solved even if the technologies in Patent Literature 1 and Non-Patent Literature 1 are simply combined.

### Solution to Problem

According to an execution monitoring device of the present invention comprising

a time-series data storage unit to store time-series data, and

a real-time specification determining unit to determine whether the time-series data stored in the time-series data storage unit satisfies a real-time specification, which is part of constraints included in a monitoring specification for electronic device runtime monitoring and is a constraint using a real time, and to update a determination result, which is a result of determining whether to satisfy the real-time specification, wherein

the real-time specification determining unit causes the determination result to be stored in a memory area reserved before execution of the real-time specification determining unit.

### Advantageous Effects of Invention

The execution monitoring device of this invention does not use a dynamic memory in retaining data required to determine a monitoring specification, and can efficiently determine a monitoring specification when a monitoring specification with a real-time constraint and a monitoring specification without a real-time constraint are present in a mixed manner.

### BRIEF DESCRIPTION OF DRAWINGS

FIG. 1 is a schematic view of an in-vehicle system including an ACC system.

FIG. 2 is a schematic view of inputs and outputs in the ACC system.

FIG. 3 illustrates monitoring specifications for the ACC system.

FIG. 4 is a timing diagram of an operator Until.

FIG. 5 a timing diagram of an operator Since.

FIG. 6 illustrates monitoring specifications described in DSL.

FIG. 7 illustrates monitoring specifications described in DSL without using Until.

FIG. 8 is a flowchart regarding creation of a Rete network.

FIG. 9 illustrates replacement results of a subexpression regarding a real-time constraint.

FIG. 10 illustrates conversion of the monitoring specifications into an AST.

FIG. 11 illustrates an AST corresponding to a monitoring specification y1.

FIG. 12 illustrates an AST corresponding to a monitoring specification y2.

FIG. 13 illustrates an AST with the monitoring specifications y1 and y2 merged.

FIG. 14 is a subgraph before decomposition.

FIG. 15 is a subgraph after decomposition.

FIG. 16 illustrates a Rete network assigned with node numbers.

FIG. 17 is a table representing a Rete network.

FIG. 18 is a diagram illustrating a process of extracting nodes to be referred to that are different only in time.

FIG. 19 is a diagram illustrating the process of extracting nodes to be referred to that are different only in time.

FIG. 20 is a diagram illustrating a process of extracting nodes to be referred to that are different only in time in the ACC system.

FIG. 21 is a diagram of the hardware configuration of an execution monitoring device 20 according to Embodiment 1.

FIG. 22 is a configuration diagram of the execution monitoring device 20 according to Embodiment 1.

FIG. 23 illustrates the data structure of a temporary buffer unit 221 according to Embodiment 1.

FIG. 24 illustrates the data structure of a determination result storage unit 224 according to Embodiment 1.

FIG. 25 illustrates the data structure of a time-series data storage unit 225 according to Embodiment 1.

FIG. 26 illustrates the data structure of a dependency relation storage unit 229 according to Embodiment 1.

FIG. 27 illustrates the data structure of an anomaly process policy storage unit 228 according to Embodiment 1.

FIG. 28 is a flowchart illustrating the operation of the execution monitoring device 20 according to Embodiment 1.

FIG. 29 is a flowchart illustrating the operation of a real-time specification determining unit 204 according to Embodiment 1.

FIG. 30 is a flowchart illustrating the operation of an invariant specification determining unit 203 according to Embodiment 1.

FIG. 31 illustrates the data structure of a calculation target storage unit 223 according to Embodiment 1.

FIG. 32 illustrates the data structure of a change time storage unit 226 according to Embodiment 1.

FIG. 33 is a diagram of the hardware configuration of an execution monitoring device 30 according to Embodiment 2.

FIG. 34 is a configuration diagram of the execution monitoring device 30 according to Embodiment 2.

FIG. 35 illustrates the data structure of a storage standard 321 according to Embodiment 2.

FIG. 36 is a flowchart illustrating the operation of the execution monitoring device 30 according to Embodiment 2.

FIG. 37 is a flowchart illustrating the operation of a signal determining unit 310 according to Embodiment 2.

### DESCRIPTION OF EMBODIMENTS

### Embodiment 1

In the following, the present embodiment is described in detail with reference to the drawings.

Note that an execution monitoring device 20 of the present embodiment can monitor execution of any electronic device. However, for convenience of description, description is made based on an example in which the present embodiment is applied to an ACC (Adaptive Cruise Control) system.

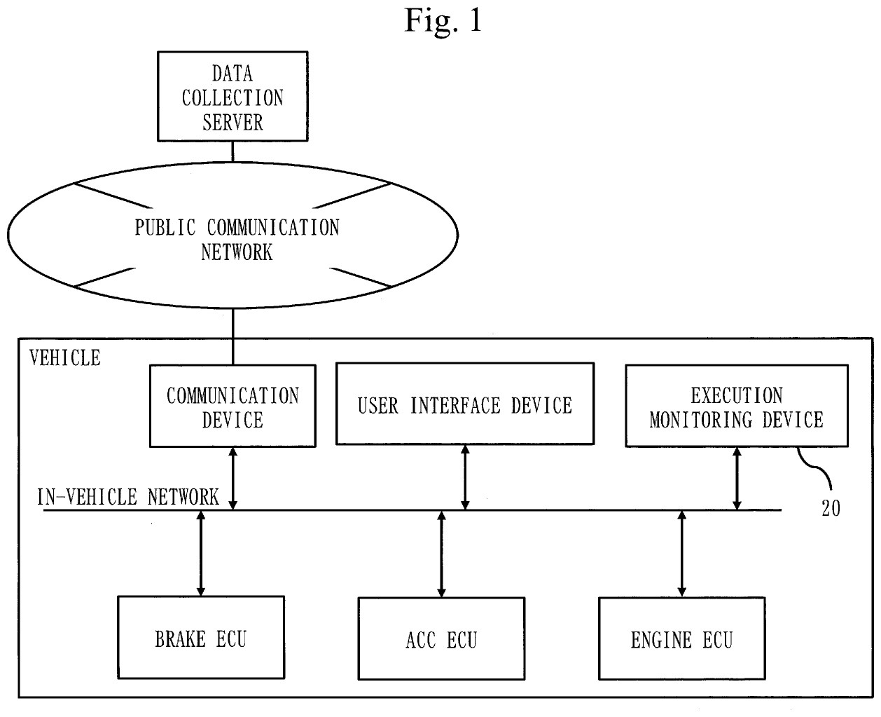

FIG. 1 is a schematic view of an in-vehicle system including an ACC system. As illustrated in the drawing, the in-vehicle system is configured of a vehicle and a data collection server, and the vehicle and the data collection server are connected via a public communication network. The vehicle includes the execution monitoring device 20, an ACC ECU (Electronic Control Unit), and so forth.

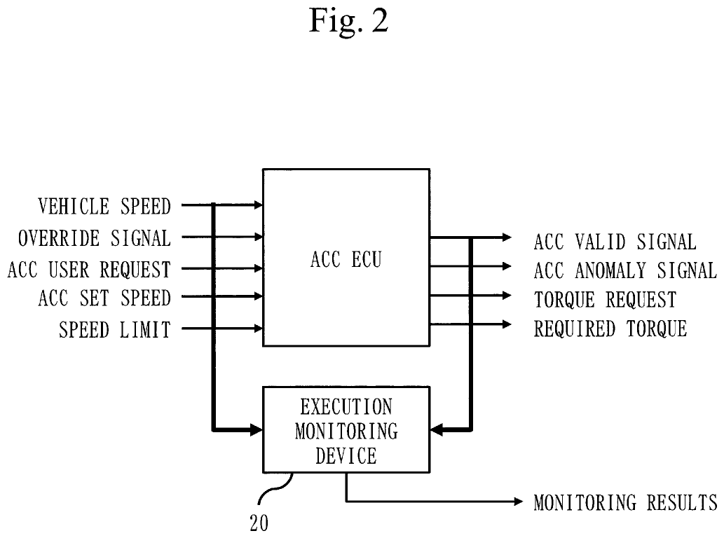

FIG. 2 is a drawing illustrating input/output signals of the ACC ECU and signals for use by the execution monitoring device 20 in determining a monitoring specification regarding runtime monitoring for an electronic device. As illustrated in the drawing, the execution monitoring device 20 determines a monitoring specification by using the input/output signals of the ACC ECU and outputs the monitoring specification determination result.

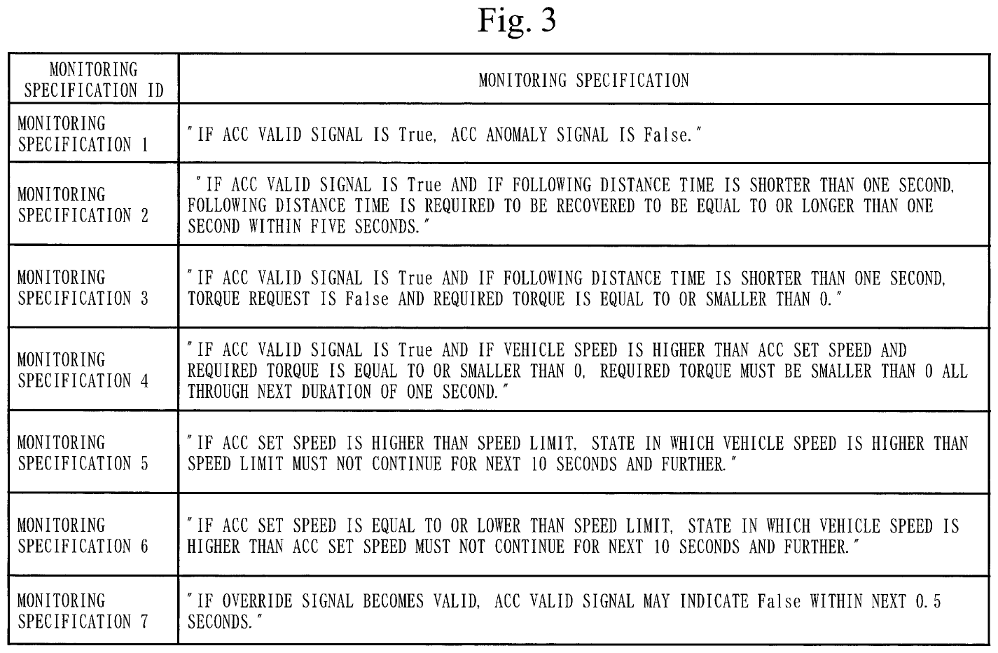

FIG. 3 illustrates specific examples of the monitoring specification. Note that the monitoring specifications in this drawing are merely examples and these monitoring specifications are not complete. A monitoring specification ID is an identifier uniquely assigned to identify a monitoring specification.

***DSL Creation Method***

A monitoring specification equation is recursively defined by using Backus-Naur form in a DSL (Domain Specific Language), as [Equation 1] below. The monitoring specification equation has part of operators regarding Boolean algebra in the C language added with logical implication and operators regarding real-time constraints, which are constraints using real time. Note that the monitoring specification equation is created with reference to MTL-B in [Non-Patent Literature 3]. The monitoring specifications handled in the present embodiment can be represented by using the monitoring specification equation.

[Equation 1]

<monitoring specification equation>::={<signal constraint>}| (1)

!<monitoring specification equation>| (2)

<monitoring specification equation_1>∥<monitoring specification equation_2>| (3)

<monitoring specification equation_1>&&<monitoring specification equation_2>| (4)

<monitoring specification equation_1>→<monitoring specification equation_2>| (5)

<monitoring specification equation_1>U[<real value 1>,<real value 2>]<monitoring specification equation_2>| (6)

<monitoring specification equation_1>S[<real value 1>,<real value 2>]<monitoring specification equation_2> (7)

In [Equation 1], three-dot leaders and notations from (1) to (7) are notations added for convenience of description to indicate items in <monitoring specification equation> and do not configure <monitoring specification equation>. Description of grammar of <monitoring specification equation> is made below.

(1) represents a truth value (“True” and “False”) of <signal constraint>. In the following, {<signal constraint>} is referred to as a signal proposition, and the truth value of the signal proposition is referred to as a signal truth value. <signal constraint> may be a single signal (which is limited to a value that can take a signal value “True” or “False”) or may be comparison among a plurality of signals. Also, <signal constraint> may be a truth value.

As specific examples, a monitoring specification denoted as {ACC valid signal} is synonymous with a monitoring specification “the ACC valid signal is “True””, and a monitoring specification denoted as {ACC set speed > speed limit} is synonymous with a monitoring specification “the ACC set speed is higher than the speed limit”. Therefore, the range of signal constraint is “True” and “False”.

In (2), “!” represents negation. As specific examples, when <monitoring specification equation> is ! {“True”}, the truth value of <monitoring specification equation> is “False”, and when <monitoring specification equation> is ! {“False”}, the truth value of <monitoring specification equation> is “True”.

In (3), “∥” represents logical OR. As specific examples, when <monitoring specification equation> is {“True”}∥{“False”}, the truth value of <monitoring specification equation> is “True”. When <monitoring specification equation> is {“False”}∥{“False”}, the truth value of <monitoring specification equation> is “False”. Note that <monitoring specification equation_1> and <monitoring specification equation_2> are equivalent to <monitoring specification equation> and they are notation to distinguish two <monitoring specification equation>.

In (4), “&&” represents logical AND. As specific examples, when <monitoring specification equation> is {“True”} && {“False”}, the truth value of <monitoring specification equation> is “False” and when <monitoring specification equation> is {“True”} && {“True” }, the truth value of <monitoring specification equation> is “True”.

In (5), “→” represents logical implication. The truth value of (5) is “True” when the truth value of <monitoring specification equation_1> is “False” or when the truth value of <monitoring specification equation_2> is “True”. As specific examples, the truth value of (5) is “True” when <monitoring specification equation> is “True”→“True” and “False”→“False”.

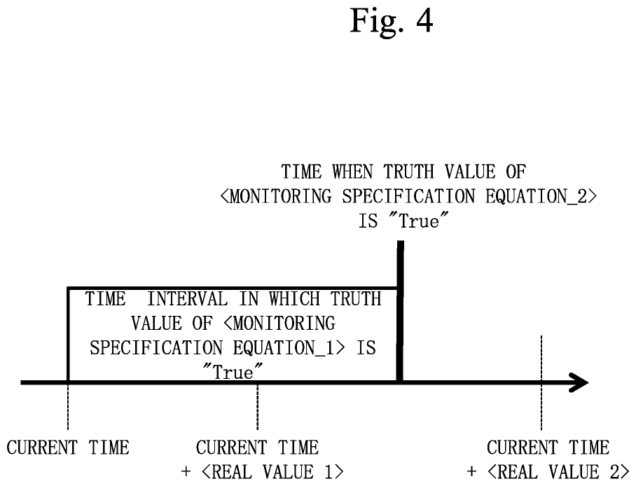

In (6), “U” represents Until. The truth value of (6) is “True” only when the truth value of <monitoring specification equation_2> is “True” at a certain time in a period from <real value 1> seconds after the current time to <real value 2> seconds after the current time and the truth value of <monitoring specification equation_1> is always “True” from the current time to the above-described time. FIG. 4 is a diagram when the truth value of (6) is “True”.

Here, <real value 1> and <real value 2> each represent a real value. As for a magnitude relation between <real value 2> and <real value 1>, <real value 2> is equal to or larger than <real value 1>.

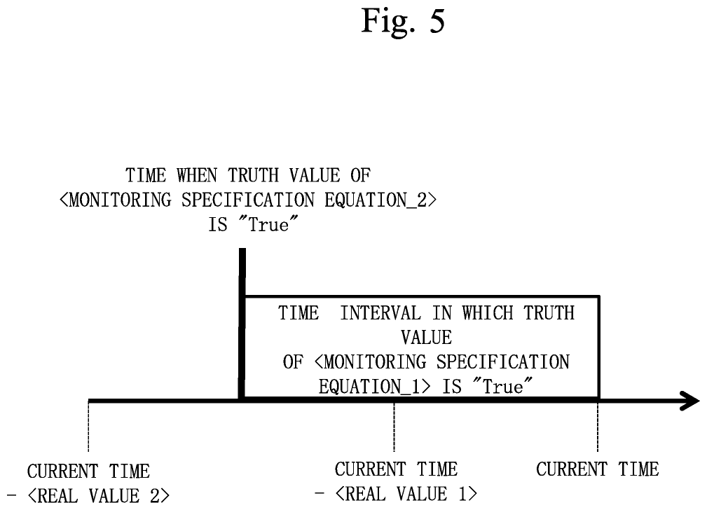

In (7), “S” represents Since. The truth value of (7) is “True” only when the truth value of <monitoring specification equation_2> is “True” at a certain time in a period from <real value 2> seconds before the current time to <real value 1> seconds before the current time and the truth value of <monitoring specification equation_1> is always “True” from the above-described time to the current time. FIG. 5 is a diagram when the truth value of (7) is “True”.

Also, the priority order of operation of <monitoring specification equation> is indicated by using parentheses.

By using the monitoring specification equation grammar, operators F_f and G_f are defined.

F_f[<real value 1>,<real value 2>]<monitoring specification equation> [Equation 2]

[Equation 2] represents “Eventually in the future”. When the truth value of [Equation 2] is “True”, the truth value of <monitoring specification equation> is “True” at a certain time in a period from <real value 1> seconds after the current time to <real value 2> seconds after the current time. F_f can be represented as in [Equation 3] by using Until.

{“True”}U[<real value 1>,<real value 2>]<monitoring specification equation> [Equation 3]

G_f[<real value 1>,<real value 2>]<monitoring specification equation> [Equation 4]

[Equation 4] represents “Always in the future”. When the truth value of [Equation 4] is “True”, the truth value of <monitoring specification equation> is always “True” from <real value 1> seconds after the current time to <real value 2> seconds after the current time. G_f can be represented as in [Equation 5] by using “Eventually in the future”.

!(F_f[<real value 1>,<real value 2>]!<monitoring specification equation>) [Equation 5]

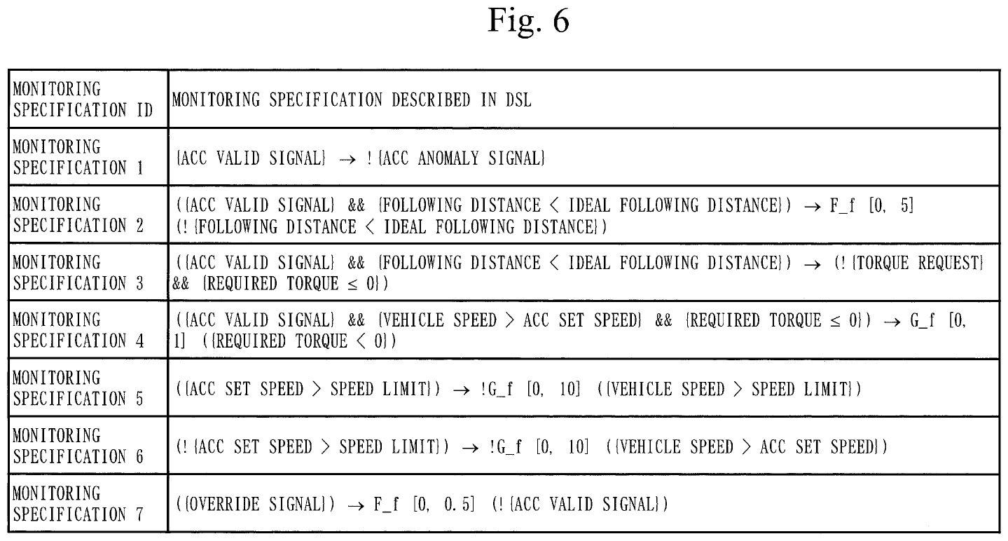

FIG. 6 illustrates the monitoring specifications illustrated in FIG. 3 by using the above-described DSL.

Meanwhile, since monitoring specifications 2, 4, 5, 6, and 7 refer to values of signal in the future from the current time, whether the truth values of the monitoring specification equations corresponding to these monitoring specifications are “True” or “False” at a certain time cannot be determined. In general, when only one monitoring specification is present, it is only required to output the monitoring result at a certain time after a predetermined time elapses from the above-described time. However, when a plurality of monitoring specifications are present, if a process similar to that when one monitoring specification is present is performed, a determination is made for each monitoring specification, thereby degrading process efficiency.

[Non-Patent Literature 3] discloses a scheme of converting a monitoring specification equation which refers to a future signal value into a monitoring specification equation which refers to a past signal value. By using the scheme, the monitoring specification equation which refers to a future signal value is converted.

For simplification of description, operators F_p and G_p are defined as follows.

F_p[<real value 1>,<real value 2>]<monitoring specification equation> [Equation 6]

[Equation 6] represents “Eventually in the past”. When the truth value of [Equation 6] is “True”, the truth value of <monitoring specification equation> is “True” at a certain time in a period from <real value 2> seconds before the current time to <real value 1> seconds before the current time. [Equation 6] can be represented as in [Equation 7] by using Since.

{“True”}S[<real value 1>,<real value 2>]<monitoring specification equation> [Equation 7]

G_p[<real value 1>,<real value 2>]<monitoring specification equation> [Equation 8]

[Equation 8] represents “Always in the past”. When the truth value of [Equation 8] is “True”, the truth value of <monitoring specification equation> is always “True” from <real value 2> seconds before the current time to <real value 1> seconds before the current time. [Equation 8] can be represented as in [Equation 9] by using “Eventually in the past”.

!(F_p[<real value 1>,<real value 2>]!<monitoring specification equation>) [Equation 9]

By using the above-described ones, a monitoring specification referring to a future value can be converted into a monitoring specification without referring to a future value.

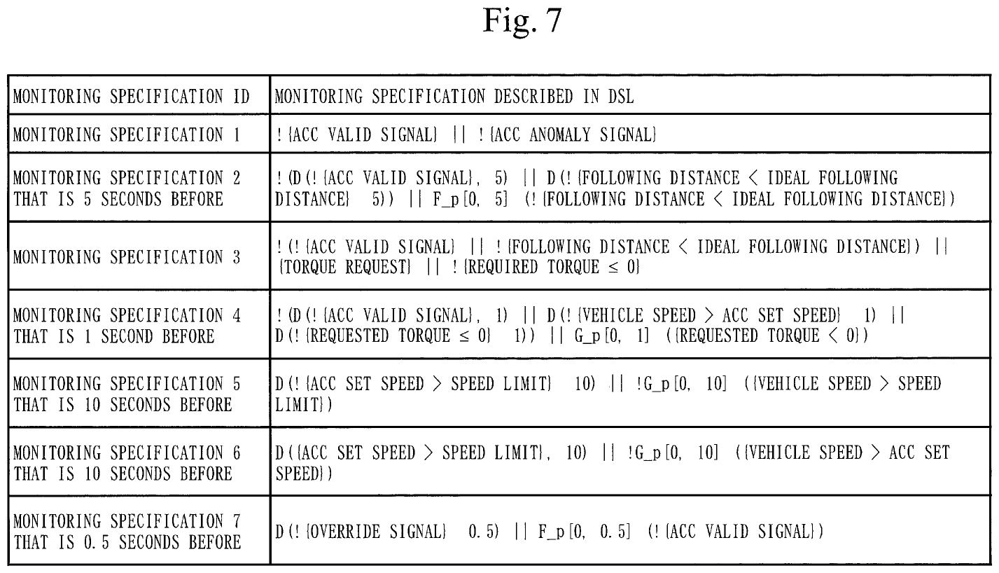

FIG. 7 illustrates the monitoring specification equations illustrated in FIG. 6 which are rewritten by using the DSL by using the scheme of [Non-Patent Literature 3]. Note that these are converted to forms without including logical AND (&&) and logical implication (imply). Here, <real value> represents a real value, and D[<monitoring specification equation>, <real value>] represents a truth value of <monitoring specification equation> based on a signal <real value> seconds before the current time.

***Rete Network Creation Method***

A method of converting the monitoring specification equation described in the DSL into a Rete network corresponding to the real-time constraint is described.

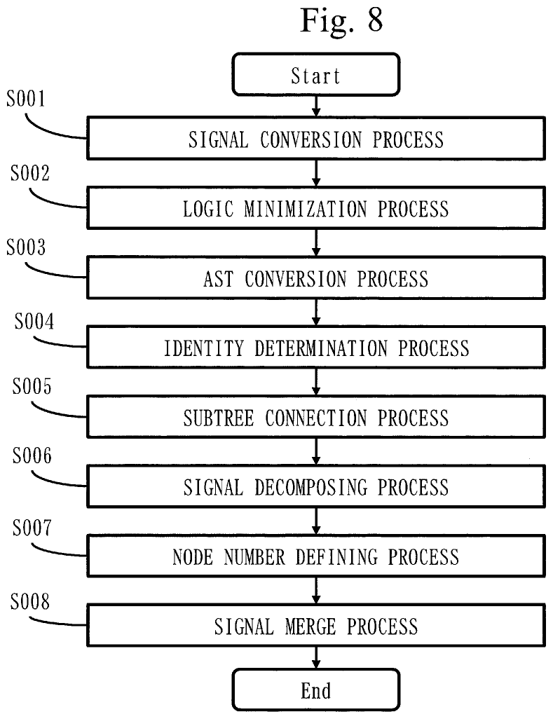

FIG. 8 is a flowchart illustrating the method.

(Step S001: Signal Conversion Process)

At step S001, to take the monitoring specification as a logical expression formed of a signal proposition, a virtual signal is introduced to convert a subexpression related to the real-time constraint into a signal proposition. The subexpression related to the real-time constraint is, specifically, a logical expression formed of only any one operator among the operator D, the operator F_p, the operator G_p, and the operator S. When the subexpression related to the real-time constraint is included in the monitoring specification, a virtual signal is introduced to convert the subexpression into a signal proposition, and the virtual signal and the monitoring specification equation corresponding to the virtual signal are recorded.

D[!{ACC valid signal},5]∥D[!{following distance<ideal following distance},5]∥F_p[0,5](!{following distance<ideal following distance}) [Equation 10]

A specific example is described in which, by using the monitoring specification equation of the monitoring specification 2 that is five seconds before indicated in [Equation 10], the subexpression related to the real-time constraint is converted into a form using a virtual signal. In [Equation 10], as subexpressions related to the real-time constraint, two operators D and one operator F_p are included.

First, a portion including D or F_p is replaced by introducing a virtual signal. The result of replacement is as follows.

{D_1}∥{D_2}∥{F_p_1} [Equation 11]

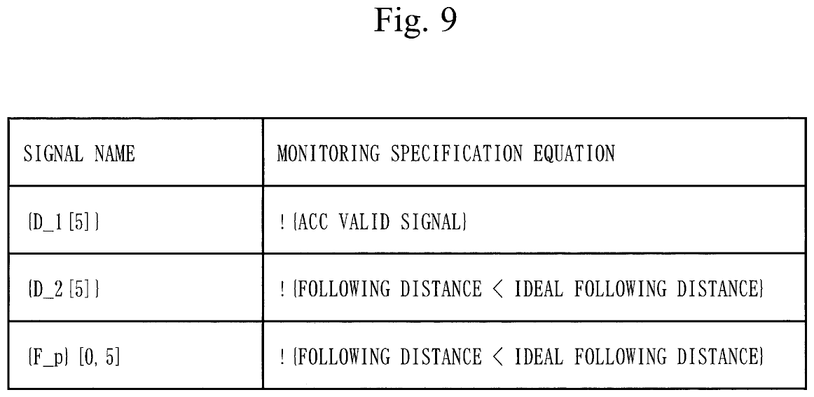

D_1, D_2, and F_p_1 are virtual signals, and the last numbers in D_1, D_2, and F_p_1 are assigned for convenience sake. As illustrated in FIG. 9, a pair formed of the signal name of the introduced virtual signal and the monitoring specification equation to which the subexpression related to the real-time constraint corresponding to the above-described signal name refers is recorded in advance. Here, in the signal name, information about the time of acquiring the signal to be referred to when the truth value of the monitoring specification equation corresponding to the above-described signal name is included. As a specific example, when description is made as D_1[5], this represents that, in obtaining the truth value of D_1[5], the truth value of the monitoring specification equation corresponding to D_1 five seconds before is to be referred to.

When the monitoring specification equation after conversion includes a subexpression related to the real-time constraint, the subexpression related to the real-time constraint is recursively converted into a signal proposition by using a virtual signal. By performing this conversion process on monitoring specification equations corresponding to all monitoring specifications, the subexpressions related to the real-time constraint in a monitoring specification equation list formed of the monitoring specification equations corresponding to the monitoring specifications can be converted to signal propositions. With this, the monitoring specification equation list can be regarded as a normal logical expression list.

(Step S002: Logic Minimization Process)

At step S002, logic minimization is applied to the monitoring specification equations in the monitoring specification equation list with all subexpressions related to the real-time constraint converted. Logic minimization is to convert a logical expression into the simplest logical expression among logical expressions in “sum-of-products” format equivalent to the above-described logical expression. With logic minimization, the calculation amount can be reduced. Note that a logical expression may be converted into a logical expression approximate to a logical expression which corresponds to logic minimization. Although logical minimization cannot be performed with polynomial time, [Non-Patent Literature 4] discloses a scheme of quickly obtaining a logical expression approximate to a logical expression which corresponds to logical minimization.

[Equation 12] is a specific example of a logical expression after logic minimization is applied to the monitoring specification equations. Note that [Equation 12] is referred to as a monitoring specification equation x. Here, <signal constraint n> may be a virtual signal. n represents a natural number.

({<signal constraint 1>}&&{<signal constraint 2>})∥({<signal constraint 3>}&&{<signal constraint 4>})∥({<signal constraint 4>}&&{<signal constraint 5>}&&{<signal constraint 6>}) [Equation 12]

(Step S003: AST Conversion Process)

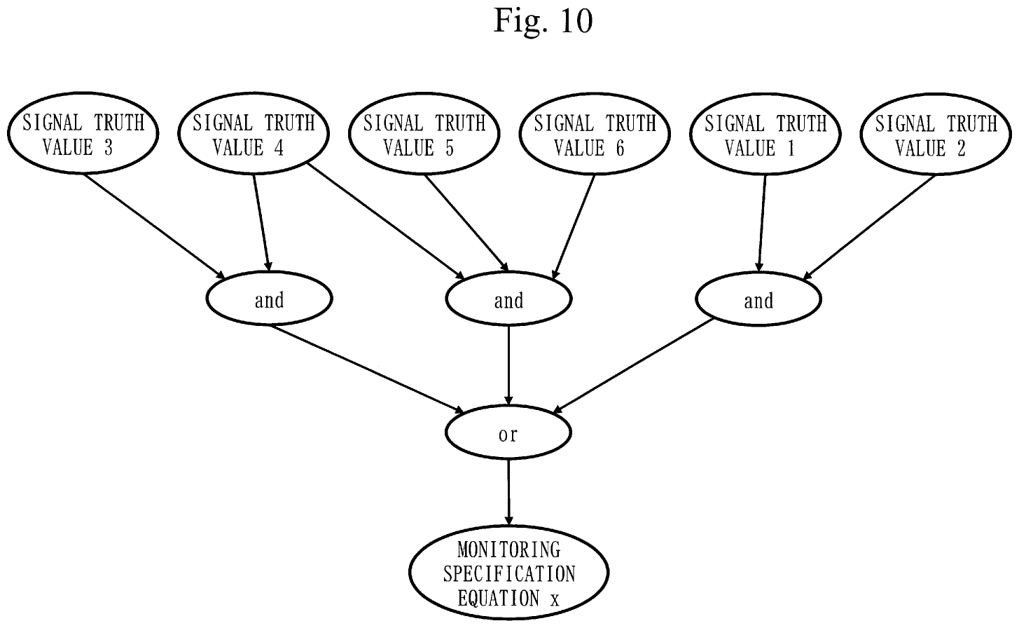

At step S003, all monitoring specification equations in the monitoring specification equation list are converted into ASTs (Abstract Syntax Trees). FIG. 10 illustrates a graph representing a monitoring specification equation x with an AST. Here, {<signal constraint n>} is denoted as a signal truth value n.

(Step S004: Identity Determination Process)

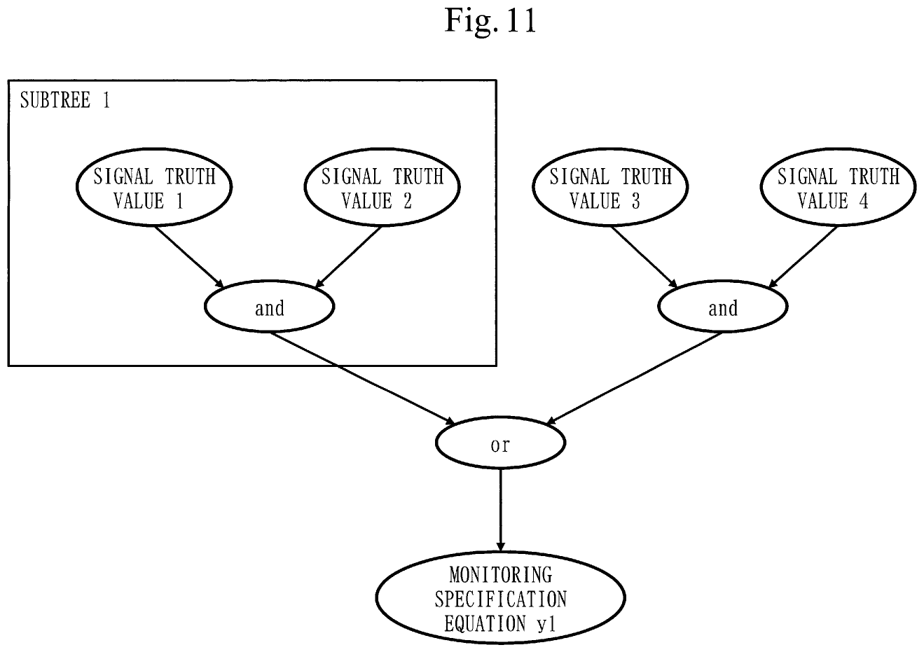

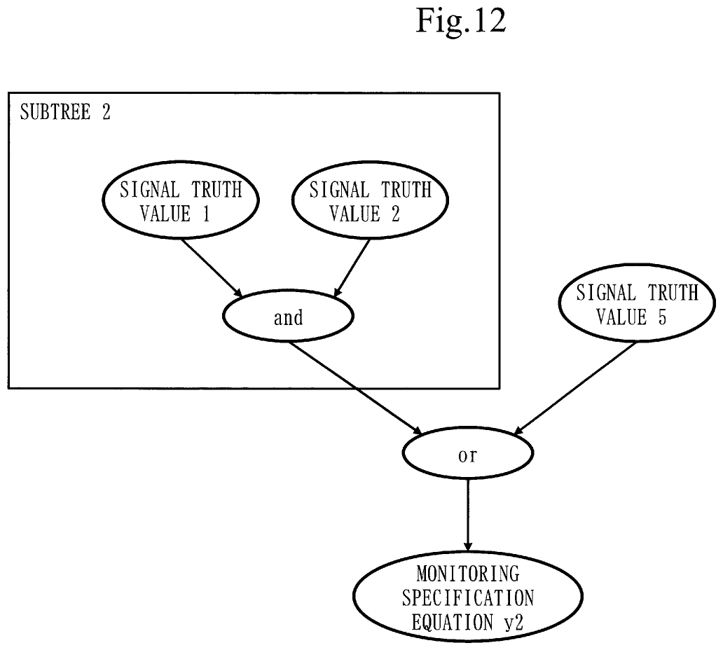

At step S004, identity determination is made for all subtrees of all monitoring specification equations in the monitoring specification equation list. By using a monitoring specification equation y1 and a monitoring specification equation y2, the process in this step is specifically described. FIG. 11 represents the monitoring specification equation y1 with an AST, and FIG. 12 represents the monitoring specification equation y2 with an AST.

A subtree 1 in FIG. 11 and a subtree 2 in FIG. 12 are the same subtrees. Note that to determine the identity of subtrees, a simple method of comparing the subtrees may be adopted, or a method of calculating a hash value of each subtree to determine the identity of the hash values may be adopted.

(Step S005: Subtree Connection Process)

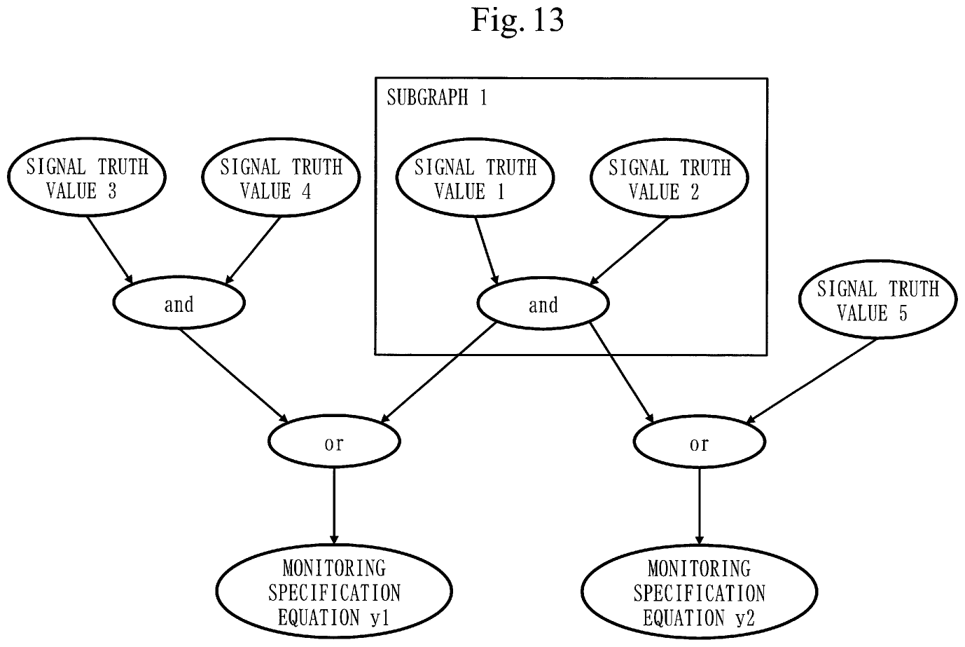

At step S005, the subtrees determined at step S004 as being the same are merged. With this, the monitoring specification equations in the monitoring specification equation list can be represented by a DAG (Directed Acyclic Graph). A graph illustrated in FIG. 13 is a graph with the AST corresponding to the monitoring specification equation y1 and the AST corresponding to the monitoring specification equation y2 merged. In the graph, a subgraph with the subtree 1 and the subtree 2 merged is taken as a subgraph 1.

(Step S006: Signal Decomposing Process)

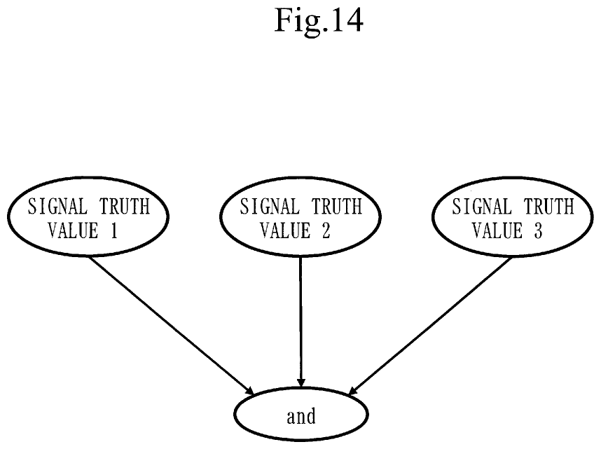

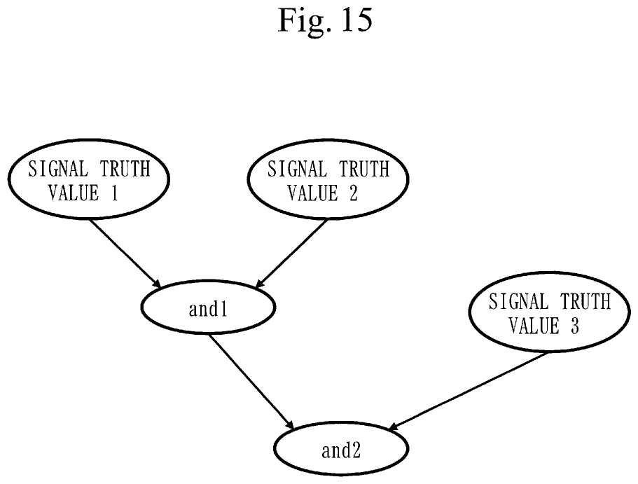

At step S006, nodes representing three or more logical OR or logical AND are converted into a plurality of nodes representing two logical OR or logical AND. As a specific example, when a subgraph illustrated in FIG. 14 is present in a graph of monitoring specification equations represented with a DAG, the subgraph is converted into a subgraph illustrated in FIG. 15.

(Step S007: Node Number Defining Process)

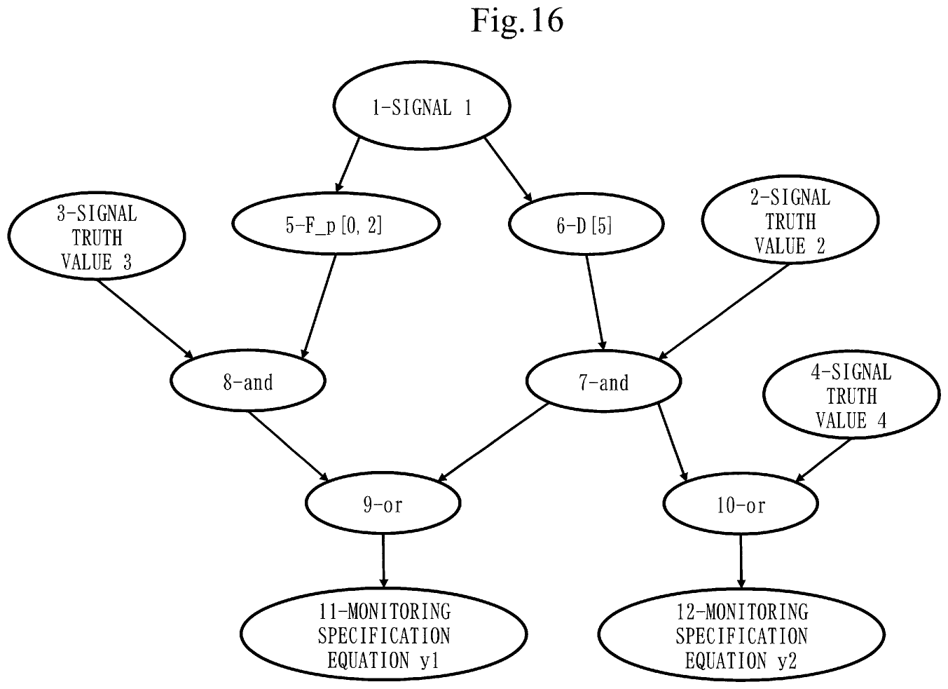

At step S007, topological sorting is performed on the Rete network. Since the Rete network is the DAG, topological sorting can be performed. FIG. 16 illustrates an example in which topological sorting is performed on the Rete network. Note that when an actual signal is referred to to obtain the signal truth value of the virtual signal, the Rete network includes the above-described signal. A number assigned to each node in the Rete network is a number assigned in connection with topological sorting. Also, the above-described number is referred to as a sub-specification number. For each node, a truth value is to be obtained, and each node represents part (hereinafter described as sub-specification) of the constraint included in the monitoring specification. Note that a node corresponding to the actual signal to be referred to when the signal truth value of the virtual signal is obtained and the nodes corresponding to the monitoring specification equation y1 and the monitoring specification equation y2 are handled as nodes representing sub-specifications and the truth value of the above-described node is the same as the truth value of the node immediately above. Sub-specification numbers indicate a sub-specification determination sequence. Edges and the orientations of the edges represent a dependency relation among the sub-specifications.

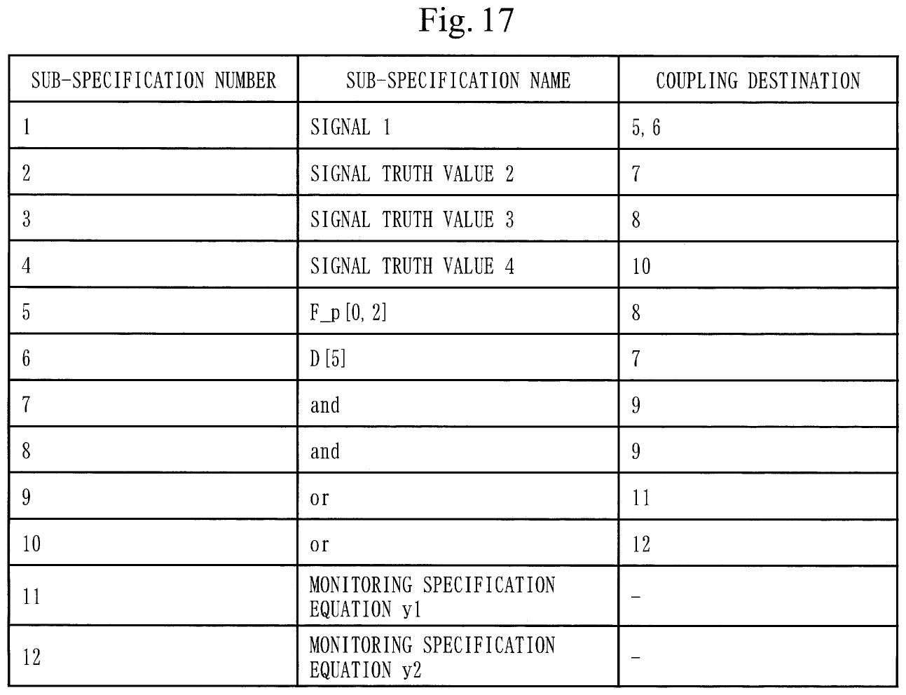

Also, FIG. 17 is a table corresponding to the Rete network illustrated in FIG. 16. Note that the signal truth value on which the node representing the real-time constraint depends is evident from the graph of the Rete network and therefore the signal name corresponding to the signal truth value is not required to be specified separately.

(Step S008: Signal Merge Process)

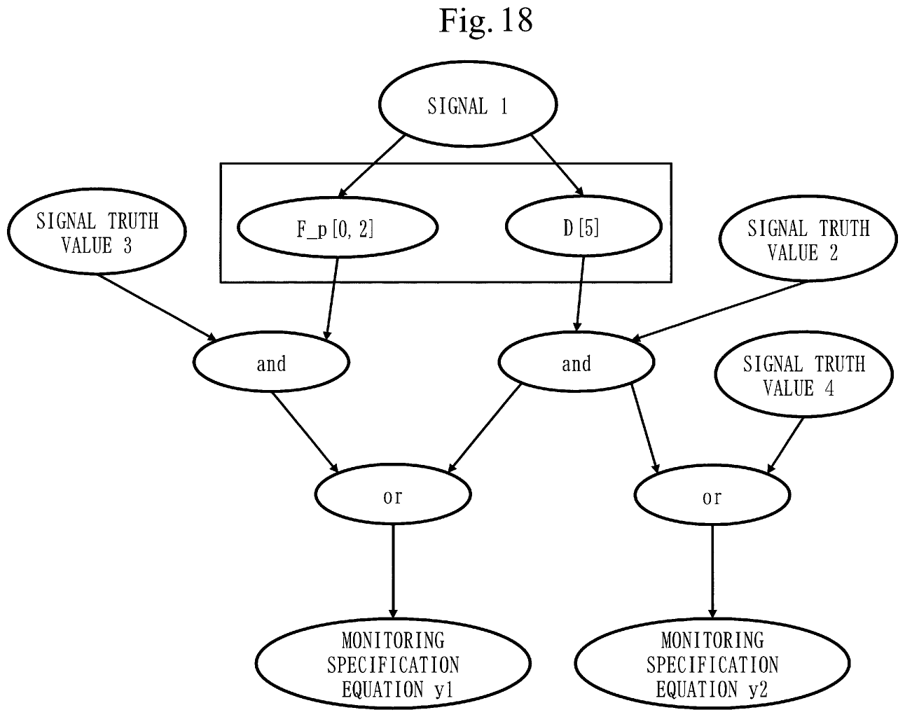

At step S008, a plurality of nodes (hereinafter, a different-time node group) are extracted, the plurality of nodes corresponding to the virtual signals and each referring to the same signal to obtain the truth value of the virtual signal, the same signal being acquired at different times to obtain the truth value. Based on a Rete network illustrated in FIG. 18, the process in this step is specifically described. In the drawing, nodes enclosed in a frame are relevant to nodes in the different-time node group.

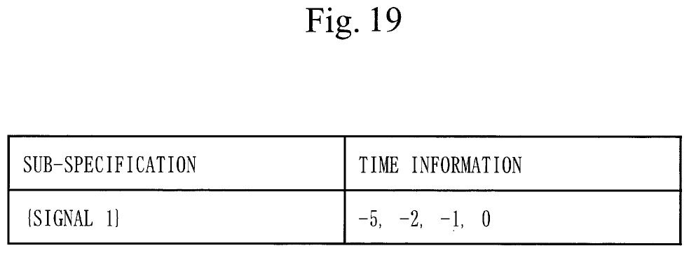

A table illustrated in FIG. 19 provides a summary of signal names of signals to which each node in the different-time node group refers to obtain a signal truth value and information about the times of acquiring the signals.

To obtain a signal truth value of F_p[x, y], a value of a signal 1 from current time−y to current time−x is required, and thus a value equal to or larger than −y and equal to or smaller than −x is recorded as time information. Note that a recording interval equal to or larger than −y and equal to or smaller than −x illustrated in this drawing is an example and the recording interval depends on the cycle in which the execution monitoring device 20 acquires a signal.

To obtain a truth value of D[z], a value of the signal 1 at current time−z is required, and thus a value of −z is recorded as time information.

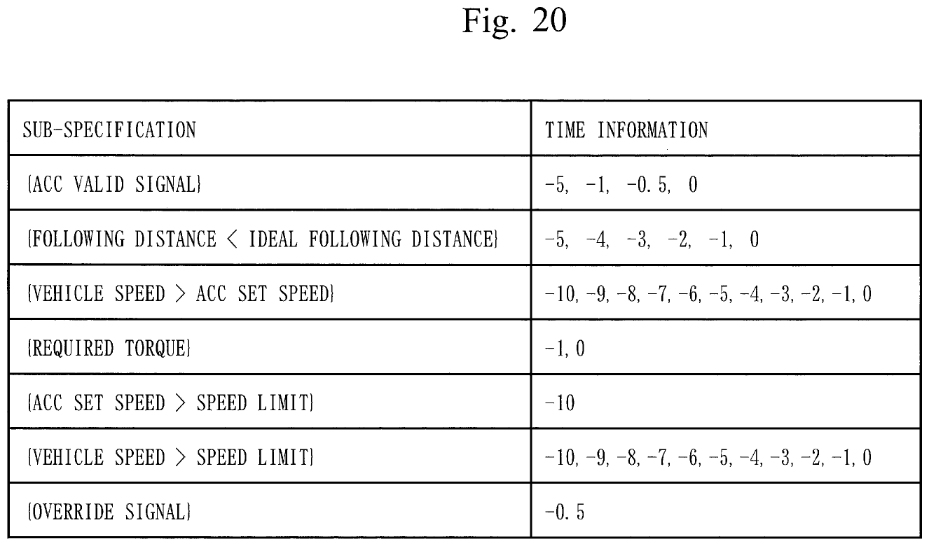

In the DAG illustrated in FIG. 18, since F_p[0, 2] and D[5] are present, the table illustrated in FIG. 19 is created. FIG. 20 is a table which provides a summary of pairs of a sub-specification and time information required for monitoring specification determination illustrated in FIG. 7.

With the procedure described above, the Rete network required to obtain the truth value of the monitoring specification including the real-time constraint can be configured so as to be able to be handled by the execution monitoring device 20 according to the present embodiment. The execution monitoring device 20 stores the table representing the Rete network illustrated in FIG. 17 and the table illustrated in FIG. 20 in which time-series data required to obtain the truth value of the monitoring specification including the real-time constraint is organized.

***Description of Structure***

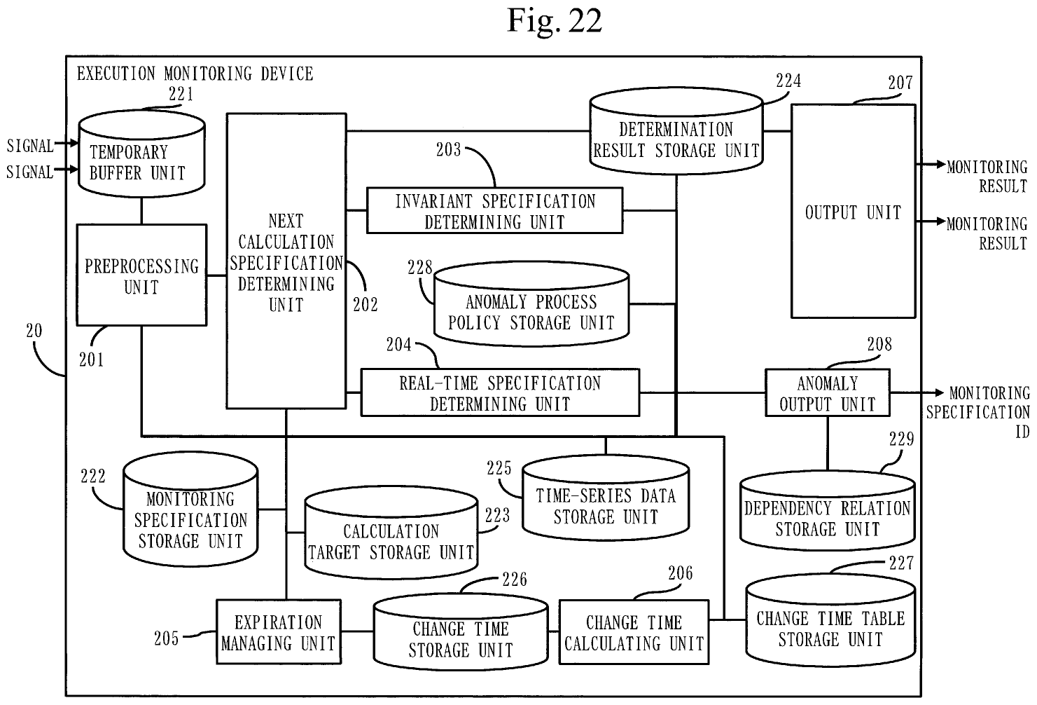

FIG. 22 is a configuration diagram of the execution monitoring device 20 according to the present embodiment.

As illustrated in this drawing, the execution monitoring device 20 includes a preprocessing unit 201, a next calculation specification determining unit 202, an invariant specification determining unit 203, a real-time specification determining unit 204, an expiration managing unit 205, a change time calculating unit 206, an output unit 207, and an anomaly output unit 208.

The preprocessing unit 201 converts the signal inputted into the temporary buffer unit 221 into a signal truth value based on the signal constraint. Specifically, the preprocessing unit 201 makes a comparison between the real value, which is a signal value, and a constant value, and so forth.

The next calculation specification determining unit 202 specifies a sub-specification to be determined in each cycle.

The invariant specification determining unit 203 determines whether to satisfy a sub-specification not including a real-time constraint, and updates the determination result, which is the result of determining whether to satisfy the above-described sub-specification stored in the determination result storage unit 224. Here, the above-described sub-specification is referred to as an invariant specification. That is, the invariant specification is a constraint formed of an operator and or operator or.

The real-time specification determining unit 204 determines whether to satisfy a sub-specification including a real-time constraint, and updates the determination result, which is the result of determining whether to satisfy the above-described sub-specification stored in the determination result storage unit 224. Here, the above-described sub-specification is referred to as a real-time specification. That is, the real-time specification is a constraint formed of the operator D, F_p, G_p, or S.

Also, the real-time specification determining unit 204 determines whether the time-series data stored in the time-series data storage unit 225 satisfies a real-time specification, which is part of the constraint included in the monitoring specification for the electronic device runtime monitoring and is a constraint using a real time, and updates the determination result, which is the result of determining whether to satisfy the real-time specification.

The output unit 207 outputs the monitoring result.

When the time-series data required for the real-time specification determining unit 204 to obtain the determination result of a real-time specification is not stored in the time-series data storage unit 225, the anomaly output unit 208 externally outputs a monitoring specification ID related to the above-described real-time specification.

That is, when the time-series data storage unit 225 does not store all pieces of time-series data for use in determining a real-time specification, the anomaly output unit 208 specifies a monitoring specification corresponding to the real-time specification with reference to the dependency relation storage unit 229, and outputs information about the monitoring specification.

The execution monitoring device 20 includes, as components arranged typically in a RAM (Random Access Memory), the temporary buffer unit 221, a calculation target storage unit 223, the determination result storage unit 224, the time-series data storage unit 225, and a change time storage unit 226.

The temporary buffer unit 221 temporarily stores a value of a signal inputted to the execution monitoring device 20. While a signal arrives at any timing, the monitoring process cyclically starts. Thus, the temporary buffer unit 221 temporarily stores the value of the above-described signal. The temporary buffer unit 221 may store a plurality of input signals corresponding to one signal.

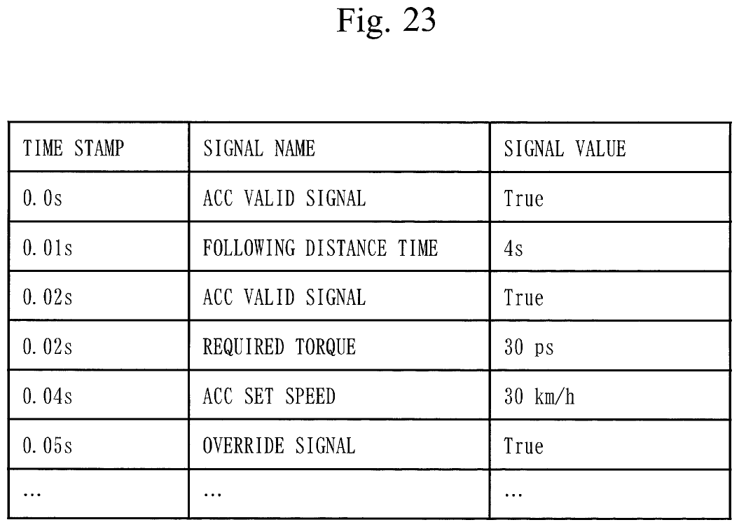

FIG. 23 illustrates an example of the data structure of the temporary buffer unit 221. The temporary buffer unit 221 stores therein a time stamp, a signal name, and a signal value in a time-series order.

The calculation target storage unit 223 stores a list of sub-specifications as targets for which the determination result is to be obtained.

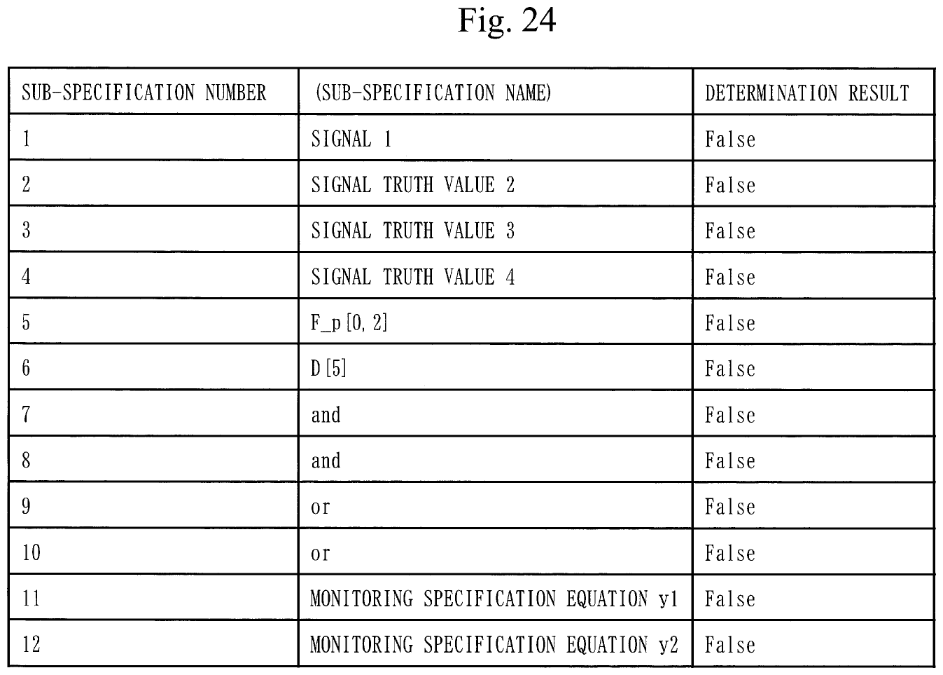

The determination result storage unit 224 stores the determination result of each sub-specification. FIG. 24 illustrates an example of the data structure of the determination result storage unit 224. The determination result storage unit 224 stores, for each sub-specification, the determination result of the sub-specification in each cycle. Note that while a sub-specification name is illustrated in FIG. 24 for reference, when the invention is implemented, the sub-specification name may not be stored. Hereinafter, the same goes for an item enclosed in parentheses in the drawings.

Also, the real-time specification determining unit 204 causes the determination result storage unit 224 to store the determination result. That is, the real-time specification determining unit 204 causes it to be stored in a memory area reserved before execution of the real-time specification determining unit 204. Here, the memory area reserved before execution is a memory area not dynamically allocated and, typically, a static area or stack area. The stack area is a memory area for storing an automatic variable and so forth. The static area is a memory area for storing a global variable and so forth.

Note that the functions of the execution monitoring device 20 are realized by an execution monitoring program being software.

The time-series data storage unit 225 stores time-series data required for determination of a real-time specification. That is, the time-series data storage unit 225 stores the determination result of a sub-specification on which a real-time specification depends. As a specific example, in the Rete network illustrated in FIG. 18, since it is only {signal 1} that the real-time specification depends on, the time-series data storage unit 225 stores the time-series data of only {signal 1}.

The determination result of the sub-specification is “True” or “False”. Thus, if the time-series data storage unit 225 stores only signal-reversed times, each unit of the execution monitoring device 20 can acquire a truth value of the above-described signal at a specific time by referring to the determination result stored in the determination result storage unit 224.

The time-series data storage unit 225 is not required to store all signal-reversed times, and storing a last reversal time, which is the last signal-reversed time, and an interval between a reversed time and a reversed time immediately before the above-described time is sufficient.

Since the execution monitoring device 20 is assumed to be mounted on an embedded system, the storable amount of time-series data has a limitation.

Thus, the time-series data storage unit 225 sets a reversal count allowed for each sub-specification depending on the real-time specification and, when the reversal count of a sub-specification exceeds the allowed reversal count corresponding to the above-described sub-specification, discards the most obsolete data in the stored time-series data of the above-described sub-specification.

Due to the above-described policy, a case occurs in which the execution monitoring device 20 cannot strictly determine a monitoring specification.

To address the above-described case, the execution monitoring device 20 may appropriately set an allowed change count in advance and, when it is required to refer to time-series data previous to the time-series data stored in the time-series data storage unit 225, may use an alternative determination result created in consideration of failsafe.

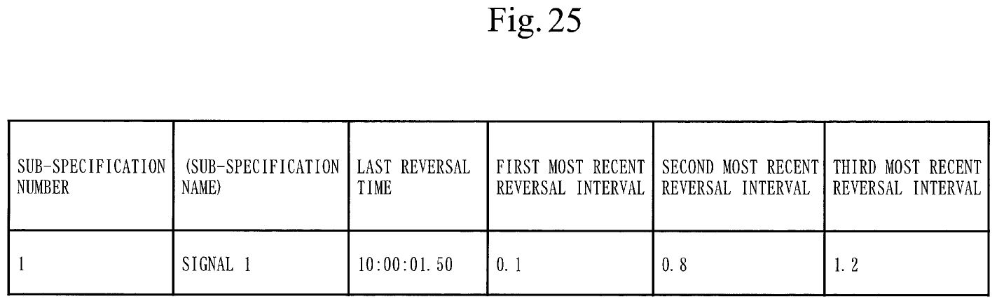

FIG. 25 illustrates an example of the data structure of the time-series data storage unit 225. In the present example, the allowed change count is set at 3.

The change time storage unit 226 stores, for each real-time specification, a time for which determination of a sub-specification is required next. In a normal Rete network, a real-time specification is not included. Thus, to specify a sub-specification to be determined, it is only required to refer to the graph of the Rete network. However, when a real-time specification is included, even if the determination result of the sub-specification on which the real-time specification depends at the time of determination is not reversed, the real-time specification may be required to be determined again because a predetermined time has elapsed.

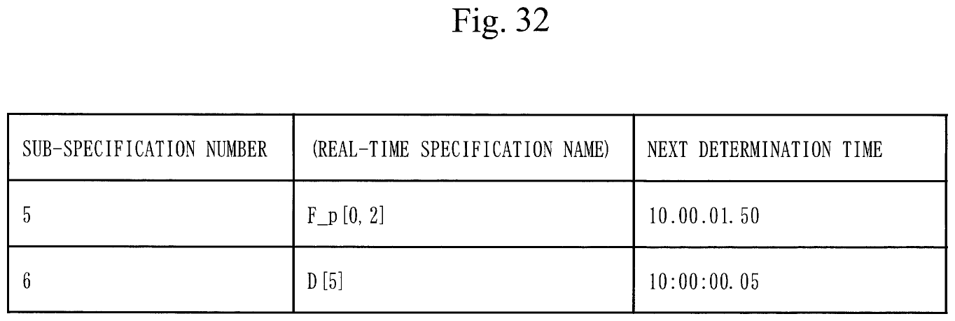

FIG. 32 illustrates an example of the data structure of the change time storage unit 226. As illustrated in this example, the change time storage unit 226 stores, for each real-time specification, a next determination time, which is a time when a determination is made next.

The execution monitoring device 20 includes, as components arranged typically in a ROM (Read Only Memory), a monitoring specification storage unit 222, a change time table storage unit 227, an anomaly process policy storage unit 228, and the dependency relation storage unit 229.

The monitoring specification storage unit 222 stores a graph structure of the monitoring specification. The monitoring specification storage unit 222 stores, as illustrated in FIG. 17, for each node, a sub-specification number, a sub-specification name, and a coupling destination node.

To determine a real-time specification depending on the sub-specification, the change time table storage unit 227 stores information about a time at which the truth value of the above-described sub-specification is required. An example of the data structure of the data stored in the change time table storage unit 227 is as illustrated in FIG. 19. The change time table storage unit 227 stores time information for each sub-specification on which the real-time specification depends.

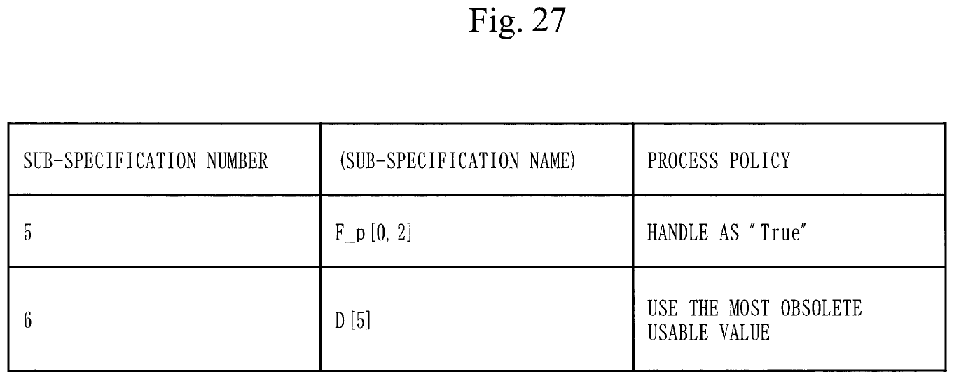

The anomaly process policy storage unit 228 stores a process policy for a case, in determination of a real-time specification, the time-series data storage unit 225 does not store all pieces of time-series data for use by the real-time specification determining unit 204 in determining the above-described real-time specification. In this case, the real-time specification determining unit 204 cannot make a correct determination. FIG. 27 illustrates an example of the data structure of the data stored in the anomaly process policy storage unit 228. The process policy is any of “handle as “True””, “handle as “False””, “use the most obsolete usable value”, and “stop determination thereafter”.

Of the process policies, “stop determination thereafter” means that a real-time specification with its process policy “stop determination thereafter” is not added to the calculation target storage unit 223.

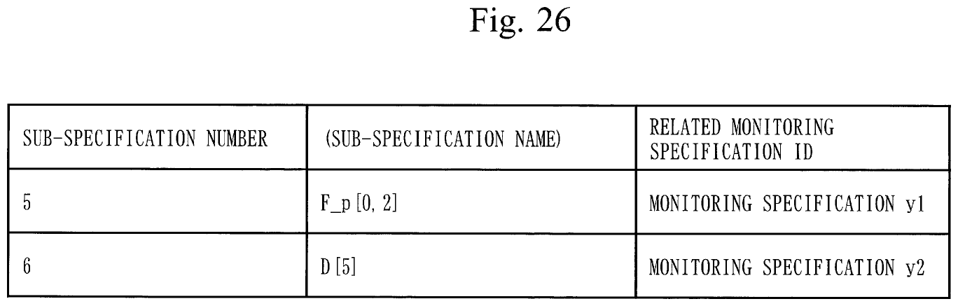

The dependency relation storage unit 229 stores, for each real-time specification, a relationship between the monitoring specification and the real-time specification. FIG. 26 illustrates an example of the data structure of data stored in the dependency relation storage unit 229. A related monitoring specification ID of this drawing indicates the monitoring specification ID of a monitoring specification related to the sub-specification. “Monitoring specification y1” and “monitoring specification y2” are monitoring specification IDs of monitoring specifications corresponding to “monitoring specification equation y1” and “monitoring specification equation y2”, respectively. Note that the related monitoring specification corresponding to the sub-specification number can be obtained by following from a node corresponding to the above-described sub-specification number of the Rete network of FIG. 16 to a direction oriented to the end point.

These components are implemented by a communication circuit in the execution monitoring device 20, a processor or digital circuit to execute a control program stored in a memory, and so forth.

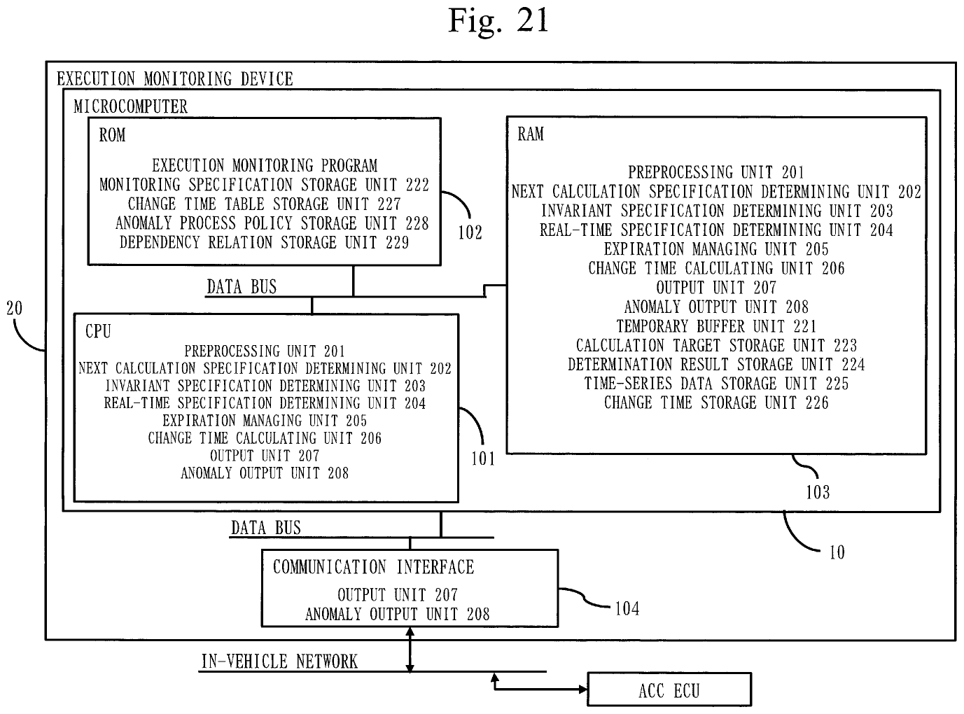

FIG. 21 is a diagram of the hardware configuration of the execution monitoring device 20 according to the present embodiment.

The execution monitoring device 20 is configured of a general microcomputer 10 and a communication interface 104 illustrated in the drawing. Note that the microcomputer 10 may be a general computer. In the computer, a microcomputer is also assumed to be included.

The preprocessing unit 201, the next calculation specification determining unit 202, the invariant specification determining unit 203, the real-time specification determining unit 204, the expiration managing unit 205, and the change time calculating unit 206 are configured of a CPU (Central Processing Unit) 101 and a RAM 103. The output unit 207 and the anomaly output unit 208 are configured of the CPU 101, the RAM 103, and the communication interface 104. The temporary buffer unit 221, the calculation target storage unit 223, the determination result storage unit 224, the time-series data storage unit 225, and the change time storage unit 226 are configured of the RAM 103. The monitoring specification storage unit 222, the change time table storage unit 227, the anomaly process policy storage unit 228, and the dependency relation storage unit 229 are configured of a ROM 102.

***Description of Operation***

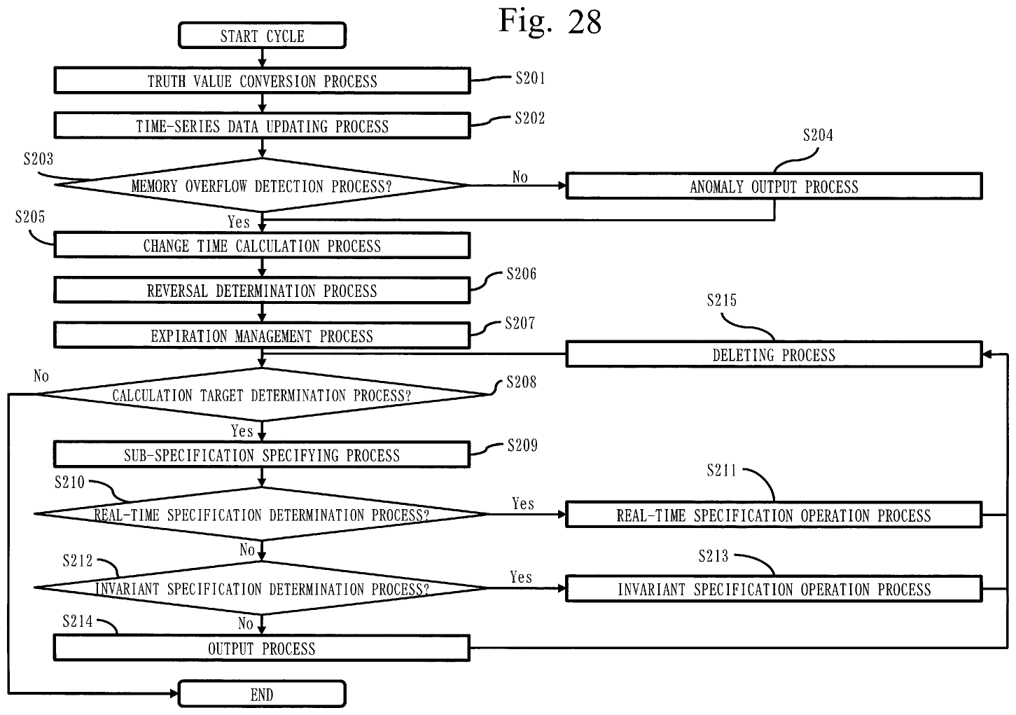

FIG. 28 is a flowchart illustrating the execution monitoring procedure by the execution monitoring device 20. The execution monitoring device 20 cyclically executes a flow illustrated at steps S201 to S215.

(Step S201: Truth Value Conversion Process)

The preprocessing unit 201 converts the signal value of the signal stored in the temporary buffer unit 221 into a signal truth value based on the signal constraint the monitoring specification has. Note that if the signal value can be used as it is as a signal truth value, the preprocessing unit 201 does not convert the input signal in practice, but, for convenience of description, the preprocessing unit 201 is assumed to convert the signal value into a signal truth value.

Also, when a plurality of signal values of a signal corresponding to a signal constraint are stored in the temporary buffer unit 221, the preprocessing unit 201 converts all of the above-described signal values into signal truth values based on the above-described signal constraint and, if at least one of the above-described signal truth values is “False”, sets the signal truth value of the above-described signal constraint as “False” and, otherwise, sets the signal truth value of the above-described signal constraint as “True”.

(Step S202: Time-Series Data Updating Process)

The preprocessing unit 201 updates the time-series data.

With reference to the change time table storage unit 227, the preprocessing unit 201 specifies a signal constraint on which the real-time specification depends and, if a signal constraint on which the real-time specification depends is present, makes a comparison, for every said signal constraint, between a truth value of the above-described signal constraint in this cycle and a truth value corresponding to the above-described signal constraint recorded on the determination result storage unit 224.

When the truth values are different from each other, the preprocessing unit 201 causes all pieces of data stored as an n-th most recent reversal interval corresponding to the above-described truth value to be stored in the time-series data storage unit 225 as an n+1-th most recent reversal interval, causes a difference between the last determination time and the current time stored in the time-series data storage unit 225 to be stored therein as a first most recent reversal interval, and causes the current time to be stored therein in the last reversal time in the time-series data storage unit 225.

Here, if the number of pieces of data corresponding to the above-described truth value stored in the time-series data storage unit 225 has already reached a storable upper limit, the preprocessing unit 201 deletes the most obsolete data among the above-described data.

(Step S203: Memory Overflow Detection Process)

When updating the data in the time-series data updating process, the preprocessing unit 201 performs memory overflow detection process for all signal constraints corresponding to all pieces of the above-described data and, otherwise, does not perform the process in this step and proceeds to step S205.

If the number of pieces of data of the n-th most recent reversal interval regarding the signal constraint stored in the time-series data storage unit 225 has already reached a storable upper limit and if a time obtained by subtracting, from the last reversal time stored in the time-series data storage unit 225, a value obtained by adding up all n-th most recent reversal intervals stored in the time-series data storage unit 225 is a future time from a time to be referred to to obtain the determination result of the real-time specification depending on the above-described signal constraint or a future time from the most previous time in the time interval, the preprocessing unit 201 judges that memory overflow is detected for the above-described signal constraint, and proceeds to step S204.

In a case other than the above, the preprocessing unit 201 proceeds to step S205.

(Step S204: Anomaly Output Process)

When detecting memory overflow for the above-described signal constraint, the preprocessing unit 201 performs process with reference to the anomaly process policy storage unit 228 by following the process policy corresponding to the above-described real-time specification.

The preprocessing unit 201 sets the determination result of the above-described real-time specification in accordance with the process policy corresponding to the above-described real-time specification.

With reference to the dependency relation stored in the dependency relation storage unit 229, the anomaly output unit 208 specifies a monitoring specification corresponding to the above-described real-time specification by specifying a monitoring specification ID, and externally outputs the monitoring specification ID, which is information about the above-described monitoring specification.

(Step S205: Change Time Calculation Process)

The change time calculating unit 206 calculates, for each real-time specification, based on the data regarding the signals stored in the time-series data storage unit 225 and the data stored in the change time table storage unit 227 on which the real-time specification depends, a future time closest to the current time among the times when the determination result of the real-time specification changes as a change time. And, the change time calculating unit 206 causes the above-described change time to be stored in the change time storage unit 226 as a next determination time of the real-time specification corresponding to the above-described time.

That is, the change time calculating unit 206 calculates, for each real-time specification, a change time when the determination result of the real-time specification changes.

(Step S206: Reversal Determination Process)

For every signal truth value of the signal constraint, the next calculation specification determining unit 202 compares the signal truth value obtained by conversion by the preprocessing unit 201 and the signal truth value stored in the determination result storage unit 224, thereby determining whether the signal truth value obtained by conversion by the preprocessing unit 201 has been reversed compared with the signal truth value in the immediately previous cycle. And, if the signal truth value has been reversed, the next calculation specification determining unit 202, with reference to the monitoring specification storage unit 222, specifies every sub-specification directly depending on the above-described signal truth value as a sub-specification with its determination result changeable, and causes every sub-specification directly depending on the above-described signal truth value to be stored in the calculation target storage unit 223. Note that if the above-described sub-specification has already been stored in the calculation target storage unit 223, the next calculation specification determining unit 202 does not cause the above-described sub-specification to be redundantly stored.

The sub-specification directly depending on the signal truth value means that, in the graph illustrated in FIG. 18, a node corresponding to the signal truth value and a node corresponding to the sub-specification are connected and the node corresponding to the signal truth value is reached by advancing from the node corresponding to the sub-specification by one to a direction oriented to the starting point. The same goes for the case in which this signal truth value is replaced by a sub-specification or the like.

(Step S207: Expiration Management Process)

If validity of the determination result of each real-time specification has expired, the expiration managing unit 205 determines that the real-time specification determining unit 204 should determine the real-time specification corresponding to the above-described determination result.

Specifically, the expiration managing unit 205 determines, for each real-time specification, whether the current time is at or after the next determination time corresponding to the real-time specification (that is, at or after the change time) and, if the current time is at or after the next determination time corresponding to the real-time specification, determines that the real-time specification determining unit 204 should determine the real-time specification corresponding to the above-described next determination time, and causes the above-described real-time specification to be stored in the calculation target storage unit 223. Note that if the above-described sub-specification have already been stored in the calculation target storage unit 223, the expiration managing unit 205 does not cause the above-described sub-specification to be redundantly stored.

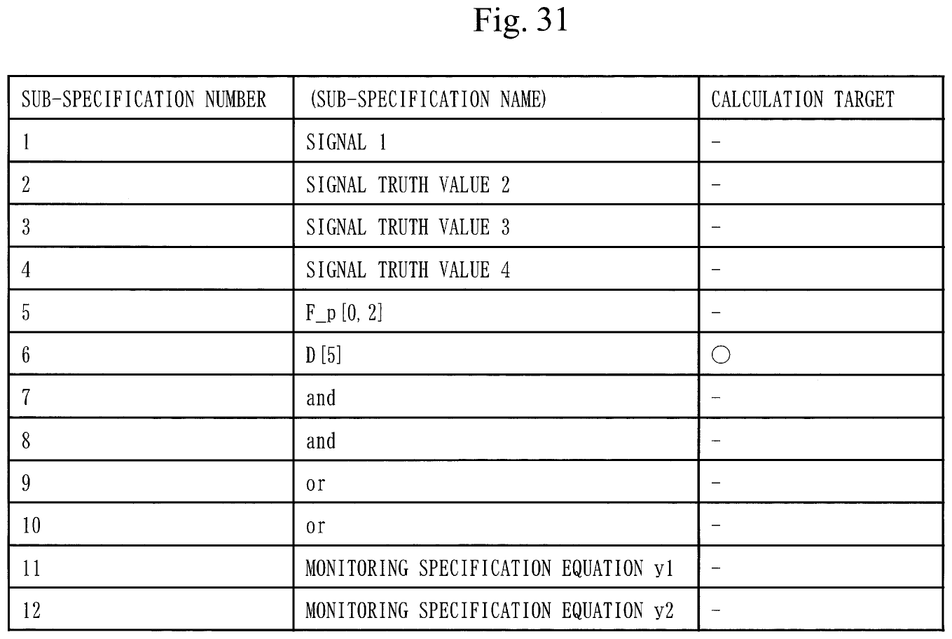

FIG. 31 illustrates an example of the data structure stored in the calculation target storage unit 223 after the process in this step. “0” represents that a sub-specification corresponding to “0” is stored in the calculation target storage unit 223 as a calculation target.

In the present example, since it is assumed that all signal truth values are not changed, the current time has not passed the next determination time of F_p[0, 2], and the current time has passed the next determination time of D[5], only D[5] is set as a calculation target.

(Step S208: Calculation Target Determination Process)

The next calculation specification determining unit 202 determines the presence or absence of a sub-specification as a calculation target. Specifically, the next calculation specification determining unit 202 determines whether a sub-specification stored in the calculation target storage unit 223 as a calculation target is present.

The execution monitoring device 20 ends the cyclic process in this cycle when the sub-specification is not present, and proceeds to step S209 when the sub-specification is present.

(Step S209: Sub-Specification Specifying Process)

The next calculation specification determining unit 202 specifies one sub-specification as a target for which the determination result is to be obtained. Specifically, the next calculation specification determining unit 202 specifies a sub-specification with the smallest sub-specification number among sub-specifications recorded as calculation targets in the calculation target storage unit 223. In the following the sub-specification specified at this step is referred to as a specified sub-specification.

(Step S210: Real-Time Specification Determination Process)

The next calculation specification determining unit 202 determines whether the specified sub-specification is a real-time specification.

(Step S211: Real-Time Specification Operation Process)

Details of this step are described at steps S301 to S312.

(Step S212: Invariant Specification Determination Process)

The next calculation specification determining unit 202 determines whether the specified sub-specification is an invariant specification.

When the sub-specification is an invariant specification, the execution monitoring device 20 proceeds to step S213 and, otherwise, proceeds to step S214.

(Step S213: Invariant Specification Operation Process)

Details of this step are described at steps S401 to S407.

(Step S214: Output Process)

The output unit 207 externally outputs the monitoring results of the monitoring specification stored in the determination result storage unit 224.

(Step S215: Deleting Process)

The next calculation specification determining unit 202 deletes the recording of the specified sub-specification from the calculation target storage unit 223. The execution monitoring device 20 proceeds to step S208.

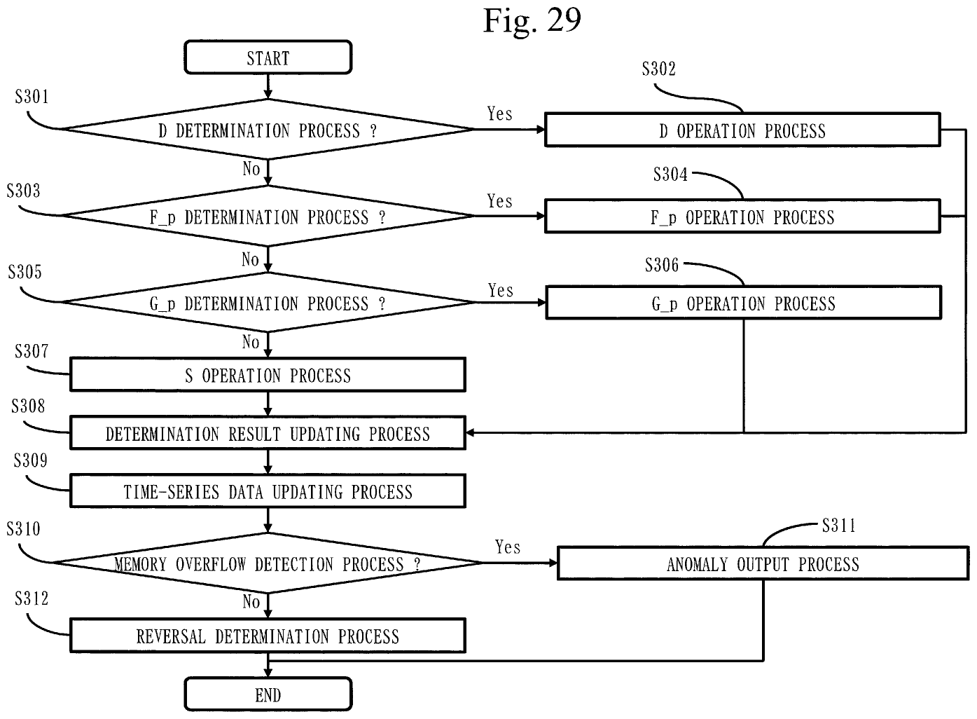

FIG. 29 is a flowchart illustrating the process of the real-time specification determining unit 204.

(Step S301: D Determination Process)

The real-time specification determining unit 204 determines whether the operator of the specified sub-specification is D.

When the operator is D, the real-time specification determining unit 204 proceeds to step S302 and, otherwise, proceeds to step S303.

(Step S302: D Operation Process)

The real-time specification determining unit 204 performs operation of the operator D. Based on the first term of the operator D, the real-time specification determining unit 204 extracts, from the time-series data stored in the time-series data storage unit 225, data at a time when the specified sub-specification is to refer to.

When the value regarding the above-described data is “True”, the real-time specification determining unit 204 produces the determination result of the specified sub-specification as “True” and, otherwise, produces the determination result of the specified sub-specification as “False”.

(Step S303: F_p Determination Process)

The real-time specification determining unit 204 determines whether the operator of the specified sub-specification is F_p.

When the operator is F_p, the real-time specification determining unit 204 proceeds to step S304 and, otherwise, proceeds to step S305.

(Step S304: F_p Operation Process)

The real-time specification determining unit 204 performs operation of the operator F_p.

Based on the first term and the second term of the operator F_p, the real-time specification determining unit 204 specifies a time interval (hereinafter, F_p reference interval) in which the truth value of the monitoring specification equation of the operator F_p is to be referred to and, from the time-series data stored in the time-series data storage unit 225, extracts data corresponding to the above-described monitoring specification equation in the F_p reference interval.

In the F_p reference interval, if at least one time when the truth value of the above-described monitoring specification equation is “True” is present, the real-time specification determining unit 204 produces the determination result of the specified sub-specification as “True” and, otherwise, produces the determination result of the specified sub-specification as “False”.

(Step S305: G_p Determination Process)

The real-time specification determining unit 204 determines whether the operator of the specified sub-specification is G_p.

When the operator is G_p, the real-time specification determining unit 204 proceeds to step S306 and, otherwise, proceeds to step S307.

(Step S306: G_p Operation Process)

The real-time specification determining unit 204 performs operation of the operator G_p.

Based on the first term and the second term of the operator G_p, the real-time specification determining unit 204 specifies a time interval (hereinafter, G_p reference interval) in which the truth value of the monitoring specification equation of the operator G_p is to be referred to and, from the time-series data stored in the time-series data storage unit 225, extracts data corresponding to the above-described monitoring specification equation in the G_p reference interval.

In the G_p reference interval, if at least one time when the truth value of the above-described monitoring specification equation is “False” is present, the real-time specification determining unit 204 produces the determination result of the specified sub-specification as “False” and, otherwise, produces the determination result of the specified sub-specification as “True”.

(Step S307: S Operation Process)

The real-time specification determining unit 204 performs operation of the operator S.

Based on the terms of the operator S, the terms corresponding to the real value 1 and the real value 2 in the definition of the operator S, of two monitoring specification equations of the operator S (at this step, a monitoring specification equation denoted on the left of S is taken as s1 and a monitoring specification equation denoted on the right of S is taken as s2), the real-time specification determining unit 204 specifies a time interval (hereinafter, an s2 reference interval) in which the truth value of s2 is to be referred to and, from the time-series data stored in the time-series data storage unit 225, extracts data corresponding to s2 in the s2 reference interval.

In the s2 reference interval, in the order in which a time corresponding to the data corresponding to s2 closer to the current time comes first, the real-time specification determining unit 204 checks whether the truth value of s2 based on the data corresponding to s2 is “True”, thereby specifying a time closest to the current time among times when the truth value of s2 is “True” in the s2 reference interval and extracting, from the time-series data stored in the time-series data storage unit 225, data corresponding to s1 in a interval (hereinafter, s1 reference interval) from the above-described time closest to the current time to the current time.

In the s1 reference interval, when the truth value of s1 based on data corresponding to s1 is always “True”, the real-time specification determining unit 204 produces the determination result of the specified sub-specification as “True” and, otherwise, produces the determination result of the specified sub-specification as “False”.

(Step S308: Determination Result Updating Process)

The real-time specification determining unit 204 updates the determination result of the specified sub-specification recorded on the determination result storage unit 224 to the determination result obtained above.

(Step S309: Time-Series Data Updating Process)

The real-time specification determining unit 204 updates the time-series data.

With reference to the change time table storage unit 227, the real-time specification determining unit 204 determines whether the specified sub-specification is depended by the real-time specification and, if the specified sub-specification is depended by the real-time specification, compares the determination result of the specified sub-specification in this cycle and the determination result corresponding to the specified sub-specification recorded on the determination result storage unit 224.

When the determination results are different from each other, the real-time specification determining unit 204 causes all pieces of data stored as an n-th most recent reversal interval corresponding to the above-described determination result to be stored in the time-series data storage unit 225 as an n+l-th most recent reversal interval, causes a difference between the last determination time stored in the time-series data storage unit 225 and the current time to be stored therein as a first most recent reversal interval, and causes the current time to be stored therein in the last reversal time in the time-series data storage unit 225. Here, n is assumed to be a natural number.

Here, if the number of pieces of data corresponding to the above-described determination result stored in the time-series data storage unit 225 has already reached a storable upper limit, the real-time specification determining unit 204 deletes the most obsolete data among the above-described data.

(Step S310: Memory Overflow Detection Process)

When updating data corresponding to the specified sub-specification in the time-series data updating process, the real-time specification determining unit 204 performs memory overflow detection process for the above-described data and, otherwise, does not perform the process in this step and ends the processes of this flowchart.

If the number of pieces of data of the n-th most recent reversal interval stored in the time-series data storage unit 225 has already reached a storable upper limit and if a time obtained by subtracting, from the last reversal time stored in the time-series data storage unit 225, a value obtained by adding up all n-th most recent reversal intervals stored in the time-series data storage unit 225 is a future time from a time to be referred to to obtain the determination result of the real-time specification depending on the specified sub-specification or a future time from the most previous time in the time interval, the real-time specification determining unit 204 judges that memory overflow is detected for the specified sub-specification, and proceeds to step S311.

(Step S311: Anomaly Output Process)

When detecting memory overflow for the specified sub-specification, the real-time specification determining unit 204 performs process with reference to the anomaly process policy storage unit 228 by following a process policy corresponding to the above-described real-time specification.

The real-time specification determining unit 204 sets the determination result of the above-described real-time specification in accordance with the process policy corresponding to the above-described real-time specification.

With reference to the dependency relation stored in the dependency relation storage unit 229, the anomaly output unit 208 specifies a monitoring specification ID related to the above-described real-time specification, and externally outputs the above-described monitoring specification ID.

(Step S312: Reversal Determination Process)

The next calculation specification determining unit 202 compares the determination result of the specified sub-specification at the above-described step and the determination result corresponding to the specified sub-specification stored in the determination result storage unit 224, thereby determining whether the determination result of the specified sub-specification has been reversed compared with the determination result in the immediately previous cycle and, if the determination result has been reversed, with reference to the monitoring specification storage unit 222, specifies the sub-specification directly depending on the specified sub-specification as a sub-specification with its determination result changeable, and causes the sub-specification directly depending on the specified sub-specification to be stored in the calculation target storage unit 223. Note that if the above-described sub-specification has already been stored in the calculation target storage unit 223, the next calculation specification determining unit 202 does not cause the above-described sub-specification to be redundantly stored.

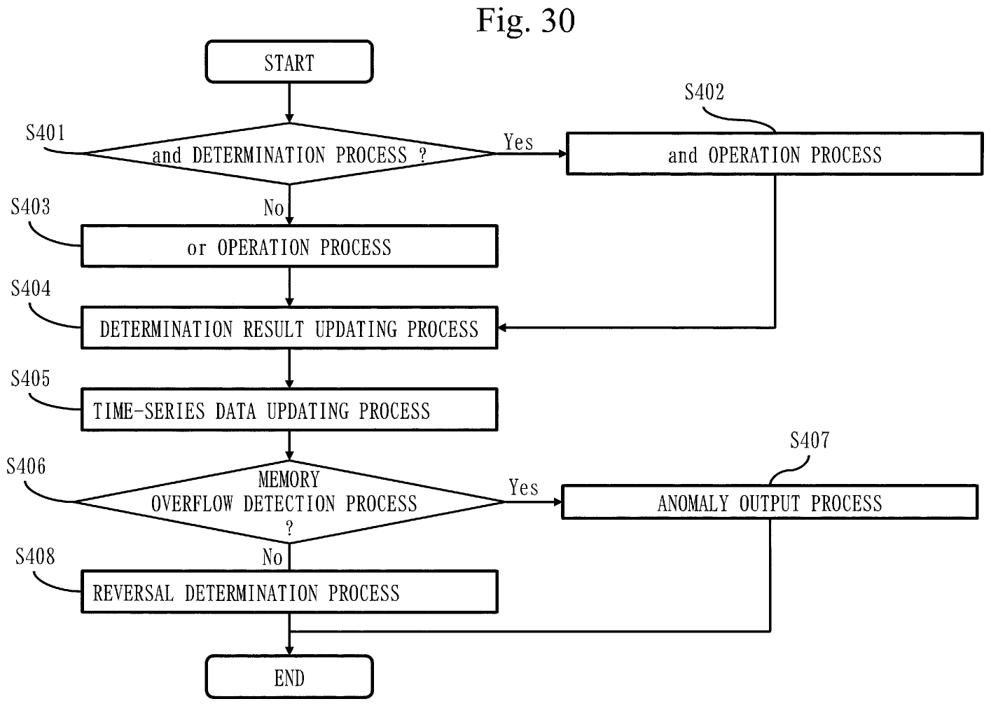

FIG. 30 is a flowchart illustrating the process of the invariant specification determining unit 203.

(Step S401: and Determination Process)

The invariant specification determining unit 203 determines whether the operator of the specified sub-specification is and.

When the operator is and, the invariant specification determining unit 203 proceeds to step S402 and, otherwise, proceeds to step S403.

(Step S402: and Operation Process)

The invariant specification determining unit 203 performs operation of the operator and.

When two truth values as inputs of the specified sub-specification are both “True”, the invariant specification determining unit 203 produces the determination result of the specified sub-specification as “True” and, otherwise, produces the determination result of the specified sub-specification as “False”.

(Step S403: or Operation Process)

The invariant specification determining unit 203 performs operation of the operator or.

When two truth values as inputs of the specified sub-specification are both “False”, the invariant specification determining unit 203 produces the determination result of the specified sub-specification as “False” and, otherwise, produces the determination result of the specified sub-specification as “True”.

The processes from steps S404 to S408 are processes similar to the processes from steps S308 to S312 and their description is therefore omitted.

### Features of Embodiment 1

If the current time is at or after the change time, the expiration managing unit 205 determines that the real-time specification determining unit 204 should determine the real-time specification corresponding to the change time, and the real-time specification determining unit 204 determines the real-time specification determined by the expiration managing unit 205 to be determined.

The execution monitoring device 20 of the present embodiment includes the next calculation specification determining unit 202 which specifies, if the determination result of the real-time specification has been changed, the sub-specification that depends on the real-time specification with its determination result changeable and is part of constraints included in the monitoring specification. The real-time specification determining unit 204 determines the real-time specification in the sub-specification specified by the next calculation specification determining unit 202.

If the determination result of the real-time specification has been changed, the next calculation specification determining unit 202 specifies the sub-specification on which the determination result depends, based on the Rete network corresponding to the monitoring specification.

If the time-series data storage unit 225 does not store all pieces of time-series data for use by the time-series data storage unit 225 in determining the real-time specification, the real-time specification determining unit 204 performs process by following the process policy, the process policy being stored in the anomaly process policy storage unit 228 and corresponding to the above-descried real-time specification.

### Application Example of Embodiment 1

The execution monitoring device 20 according to the present embodiment can monitor execution of robots and trains. Specifically, it is only required that the signals illustrated in FIG. 2 for use by the execution monitoring device 20 in determining a monitoring specification are replaced as appropriate by signals generated at the time of execution of these to create monitoring specifications as illustrated in FIG. 3 and the monitoring specifications are represented by using a DSL.

### Description of Effects of Embodiment 1

As has been described above, according to the present embodiment, by using the determination method based on the Rete algorithm, a determination is made for only a sub-specification, the determination result of which can be changed. Thus, the execution monitoring device 20 according to the present embodiment can efficiently determine the monitoring specification.

Also, in a case in which the monitoring result becomes indefinite because the time-series data storage unit 225 cannot retain the time-series data required for determination of the monitoring specification, the execution monitoring device 20 detects the above-described case and notifies outside of falling into the above-described case. Also, in the above-described case, the execution monitoring device 20 performs process with reference to the anomaly process policy storage unit 228, and thus the monitoring result is put on a safety side.

### Modification Example 1

In the present embodiment, description is made to the case in which each function of the execution monitoring device 20 is implemented by software. However, as a modification example, each of the functions may be implemented by hardware.

When each of the functions is implemented by hardware, the microcomputer 10 includes an electronic circuit (processing circuit) in place of the CPU 101. Alternatively, the microcomputer 10 includes an electronic circuit in place of the CPU 101, the ROM 102, and the RAM 103. The electronic circuit is a dedicated electronic circuit which implements each of the functions (and the ROM 102 and the RAM 103).

The electronic circuit is assumed to be a single circuit, composite circuit, programmed processor, parallel-programmed processor, logic IC, GA (Gate Array), ASIC (Application Specific Integrated Circuit), or FPGA (Field-Programmable Gate Array).

Each of the functions may be implemented by a single electronic circuit or each of the functions may be implemented as being dispersed into a plurality of electronic circuits.

Alternatively, part of the functions may be each implemented by hardware and the other functions may be each implemented by software.

The above-described CPU 101, RAM 103, ROM 102, and electronic circuit are collectively referred to as “processing circuitry”. That is, each of the functions is implemented by the processing circuitry.

### Embodiment 2

In the following, points different from the above-described embodiment are mainly described with reference to the drawings.

***Description of Structure***

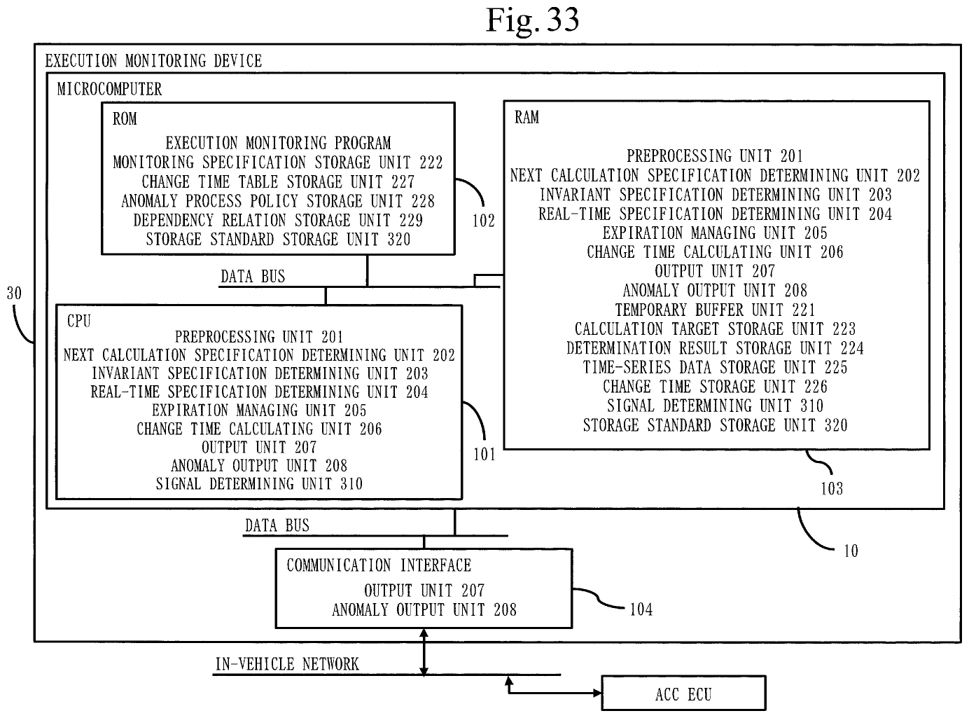

FIG. 33 illustrates an example of hardware configuration of an execution monitoring device 30. A difference between the execution monitoring device 20 and the execution monitoring device 30 is that the execution monitoring device 30 includes a signal determining unit 310 and a storage standard storage unit 320. Except the signal determining unit 310 and the storage standard storage unit 320, the execution monitoring device 30 is similar to the execution monitoring device 20.

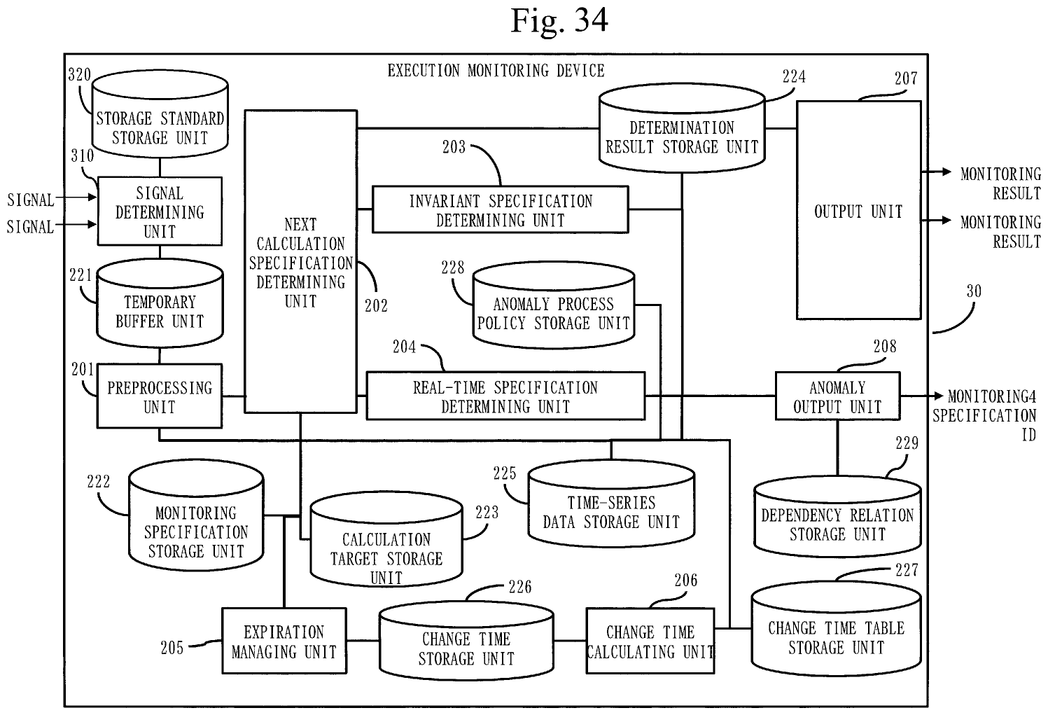

FIG. 34 illustrates an example of configuration of the execution monitoring device 30. The execution monitoring device 30 includes, as illustrated in this drawing, the signal determining unit 310 and the storage standard storage unit 320.

The signal determining unit 310 determines a reception signal by using determination items 322 and reference values 323.

The signal determining unit 310 acquires a storage standard 321 with reference to the storage standard storage unit 320, and determines whether the reception signal satisfies the storage standard 321. The storage standard 321 is used to determine whether to store the reception signal in the time-series data storage unit 225. The reception signal is a signal corresponding to the time-series data and is a signal received by the execution monitoring device 30. The signal corresponding to the time-series data is also a signal for use to generate time-series data.

The reception signal includes a signal name. The signal name indicates the name of the reception signal. The reception signal includes information about the time corresponding to the reception signal. The reception signal typically includes information about the time when a sensor or the like acquired data included in the reception signal. The execution monitoring device 30 may receive a signal as a reception signal.

The signal determining unit 310 determines whether the reception signal satisfies the storage standard 321. When the reception signal satisfies the storage standard 321, the signal determining unit 310 causes the reception signal to be stored in the temporary buffer unit 221. The preprocessing unit 201 causes, as with Embodiment 1, the above-described reception signal to be stored in the time-series data storage unit 225. That the above-described reception signal is stored in the time-series data storage unit 225 in this manner also means that the signal determining unit 310 causes the above-described reception signal to be stored in the time-series data storage unit 225. That is, the signal determining unit 310 causes the reception signal to be stored in the time-series data storage unit 225.

The storage standard storage unit 320 stores the storage standard 321.

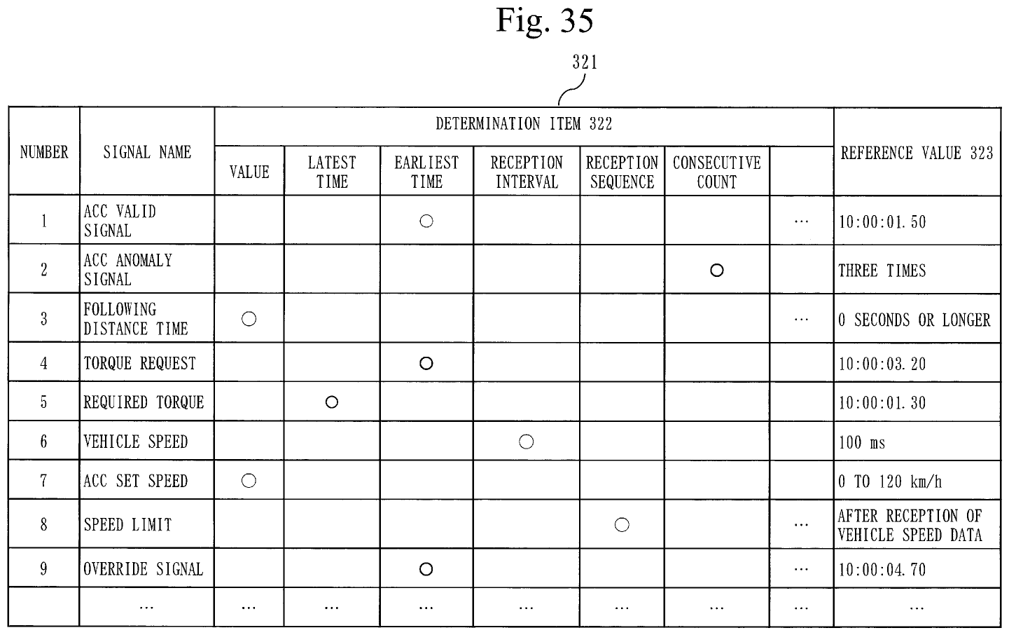

FIG. 35 illustrates an example of the data structure of the storage standard 321. Details of the storage standard 321 may differ depending on the time when the storage standard 321 is acquired. In the following, the storage standard 321 illustrated in this drawing is assumed to be acquired at a reference acquisition time.

The storage standard storage unit 320 stores, as illustrated in this drawing, the determination items 322 and the reference values 323 as being linked to the signal names. Numbers are serial numbers assigned to the signal names. “ . . . ” in the drawing indicates that the count of each item is not limited, for example.

The determination items 322 indicates viewpoints for the signal determining unit 310 to determine the reception signal. Each of “value”, “latest time”, “earliest time”, “reception interval”, “reception sequence”, and “consecutive count” is a specific example of the determination items 322. The viewpoints for the signal determining unit 310 to determine the reception signal are each indicated by a “0” mark in a box of the determination item 322 for each signal name.

“Value” indicates that when the reception signal indicates a predetermined value, the signal determining unit 310 causes the reception signal to be stored.

“Latest time” indicates that the signal determining unit 310 causes the latest data to be stored. When the signal determining unit 310 determines the reception signal by following “latest time”, the signal determining unit 310 causes the reception signal to be stored when the time indicated by the reception signal is newer than the latest time. The latest time is the newest time among all times indicated by signals which correspond to the signal name indicated by the reception signal and are received by a reference acquisition time.

“Earliest time” indicates that the signal determining unit 310 causes the most obsolete data to be stored. When the signal determining unit 310 determines the reception signal by following “earliest time”, the signal determining unit 310 causes the reception signal to be stored when the time indicated by the reception signal is older than the earliest time. The earliest time is the oldest time among all times indicated by signals which correspond to the signal name indicated by the reception signal and are received by the reference acquisition time.

“Reception interval” indicates that the signal determining unit 310 causes the reception signal to be stored if a predetermined time elapses from the previous time of receiving a reception signal.

“Reception sequence” indicates that the signal determining unit 310 causes the reception signal to be stored if a sequence in which the execution monitoring device 30 has received reception signals is a predetermined sequence.

“Consecutive count” indicates that the signal determining unit 310 causes the reception signal to be stored if the execution monitoring device 30 has received reception signals consecutively a predetermined number of times.

The reference values 323 corresponds to the determination items 322. As a specific example, in FIG. 35, if a “0” mark is provided to a box of “latest time” in a certain row, the reference value 323 on that row indicates the latest time.

The signal determining unit 310 uses the reference values 323 to determine the reception signal. Also, the signal determining unit 310 updates the data of the reference values 323 as appropriate.

As a specific example, when the signal name corresponding to the reception signal is “torque request”, the signal determining unit 310 determines the reception signal in accordance with “earliest time”. Here, as the earliest time, the signal determining unit 310 uses “10:00:03.20”. In this example, if the time indicated by the reception signal is a time older than the earliest time, the signal determining unit 310 updates the reference value 323 corresponding to “torque request” to the time indicated by the reception signal.

Like the reference value 323 corresponding to “ACC set speed” in FIG. 35, the reference value 323 may indicate a range. When the reference value 323 indicates a range, the signal determining unit 310 checks whether the value indicated by the reception signal falls within the range indicated by the reference value 323.

Like the reference value 323 corresponding to “speed limit” in FIG. 35, the reference value 323 may include information other than a value.

The determination items 322 and the reference values 323 may be determined based on the monitoring specification storage unit 222. In the following, based on FIG. 3 and FIG. 35, a specific example of a relation between the monitoring specification storage unit 222 and the determination items 322 and the reference values 323 is described.

The execution monitoring device 30 uses one unit of the ACC valid signal in one determination process. The data format of the ACC valid signal is a truth value.

Also, the value of the ACC valid signal is normally unchanged in a predetermined period. Thus, the signal determining unit 310 is only required to cause only the ACC valid signal received by the execution monitoring device 30 first in the predetermined period to be stored. Therefore, in FIG. 35, “0” is written in a box of “earliest time” as the determination item 322 corresponding to the ACC valid signal. In the following, although not mentioned in FIG. 35, description corresponding to the description of the determination items 322 and the reference values 323 in FIG. 35 is also written.

The ACC anomaly signal is normally not changed frequently. Thus, the signal determining unit 310 is only required to cause the ACC anomaly signal to be stored if the execution monitoring device 30 has received ACC anomaly signals having the same value consecutively three times.

A range of the following distance time to be handled by the execution monitoring device 30 in the determination process is equal to or larger than 0. Thus, the signal determining unit 310 is only required to cause the following distance time to be stored if the value of the following distance time is equal to or larger than 0.

The execution monitoring device 30 uses one unit of the torque request in one determination process. The data format of the torque request is a truth value. Also, the value of the torque request is normally unchanged in a predetermined period. Thus, the signal determining unit 310 is only required to cause only the torque request at the earliest time to be stored.

The execution monitoring device 30 uses one unit of the required torque in one determination process. The data format of the required torque is a real number. Also, the value of the required torque may change in a predetermined period. Thus, the signal determining unit 310 is only required to cause only the required torque at the latest time to be stored.

100 pieces of vehicle speed data acquired within 10 seconds are a sufficient amount when the execution monitoring device 30 determines a speed. Here, the vehicle speed data is data included in a vehicle speed signal. Thus, the signal determining unit 310 is only required to cause vehicle speed data with a reception interval set as 100 ms to be stored.

A range of the ACC set speeds handled by the execution monitoring device 30 in determination process is equal to or more than 0 km/h and equal to or less than 120 km/h. Thus, the signal determining unit 310 is only required to cause the ACC set speed to be stored when the value of the ACC set speed is within the range equal to or more than 0 km/h and equal to or less than 120 km/h.

It is assumed that the execution monitoring device 30 consecutively receives two signals and the second signal indicates a speed limit. When the first signal indicates a vehicle speed, the signal determining unit 310 causes the second signal to be stored. However, when the first signal does not indicate a vehicle speed, the signal determining unit 310 does not cause the second signal to be stored.

The execution monitoring device 30 uses one unit of the override signal in one determination process. The data format of the override signal is a truth value. Also, the override signal is normally unchanged in a predetermined period. Thus, the signal determining unit 310 is only required to cause only the override signal at the earliest time to be stored.

***Description of Operation***

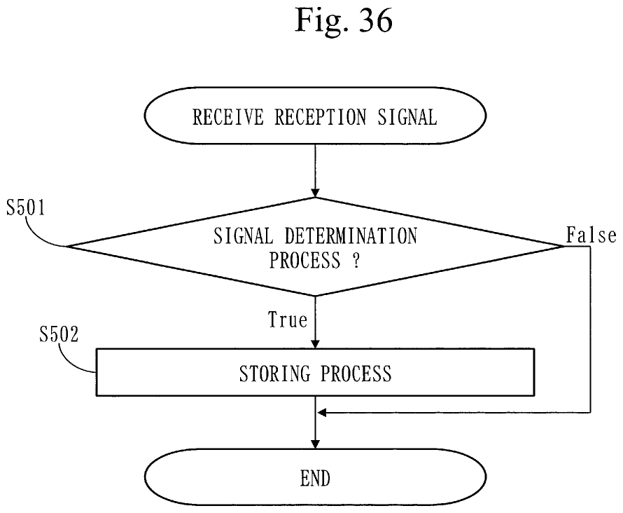

FIG. 36 is a flowchart illustrating an example of operation of the execution monitoring device 30. With reference to this drawing, the operation of the execution monitoring device 30 is described.

With signal reception by the execution monitoring device 30 as a trigger, the execution monitoring device 30 performs processes illustrated in this flowchart. Before the execution monitoring device 30 performs the processes illustrated in this flowchart, the storage standard storage unit 320 is assumed to store the storage standard 321.

(Step S501: Signal Determination Process)

The signal determining unit 310 acquires the storage standard 321 with reference to the storage standard storage unit 320, and determines whether the reception signal satisfies the storage standard 321.

When the reception signal satisfies the storage standard 321, the signal determining unit 310 produces the result of the signal determination process as “True”.

Otherwise, the signal determining unit 310 produces the result of the signal determination process as “False”.

When the result of this process is “True”, the signal determining unit 310 proceeds to step S502. When the result of this process is “False”, the signal determining unit 310 ends the processes of this flowchart.

(Step S502: Storing Process)

The signal determining unit 310 stores the reception signal in the temporary buffer unit 221.

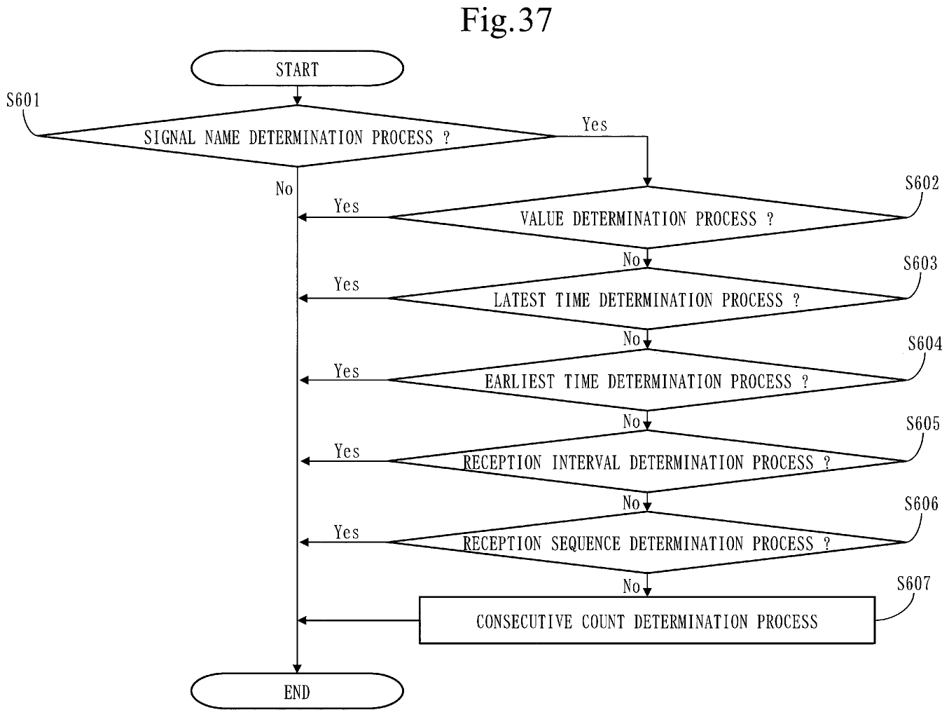

FIG. 37 is a flowchart illustrating one example of operation of the signal determining unit 310 in the signal determination process illustrated at step S501. With reference to this drawing, the operation of the execution monitoring device 30 is described.

Note in this example that the determination items 322 are assumed to be “value”, “latest time”, “earliest time”, “reception interval”, “reception sequence”, and “consecutive count” only. The length of the flowchart illustrating the operation of the signal determining unit 310 in the signal determination process depends on the number of items included in the determination items 322.

(Step S601: Signal Name Determination Process)

The signal determining unit 310 determines whether the signal name included in the reception signal has been registered in the storage standard 321.

If the signal name included in the reception signal has been registered in the storage standard 321, the signal determining unit 310 proceeds to step S602. Otherwise, the signal determining unit 310 produces the result of the signal determination process as “False”, and ends the processes of this flowchart.

(Step S602: Value Determination Process)

The signal determining unit 310 makes a determination as to “value” as the determination item 322.

When the determination item 322 corresponding to the reception signal is “value” and the value indicated in the reception signal is relevant to the value indicated in the reference value 323 corresponding to the reception signal, the signal determining unit 310 produces the result of the signal determination process as “True”, and ends the processes of this flowchart.

Here, the determination item 322 corresponding to the reception signal is the determination item 322 corresponding to the signal name indicated by the reception signal. The reference value 323 corresponding to the reception signal is similar to the determination item 322 corresponding to the reception signal. As a specific example, when the storage standard 321 is as illustrated in FIG. 35 and the signal name indicated by the reception signal is “ACC set speed”, the determination item 322 corresponding to the reception signal is “value” and the reference value 323 corresponding to the reception signal is “0 to 120 km/h”. “0 to 120 km/h” indicates 0 km/h or more and 120 km/h or less.

Otherwise, the signal determining unit 310 proceeds to step S603.

(Step S603: Latest Time Determination Process)

The signal determining unit 310 makes a determination as to “latest time” as the determination item 322.

When the determination item 322 corresponding to the reception signal is “latest time” and the time indicated in the reception signal is newer than the time indicated in the reference value 323 corresponding to the reception signal, the signal determining unit 310 produces the result of the signal determination process as “True”, and ends the processes of this flowchart.

Otherwise, the signal determining unit 310 proceeds to step S604.

(Step S604: Earliest Time Determination Process)

The signal determining unit 310 makes a determination as to “earliest time” as the determination item 322.

When the determination item 322 corresponding to the reception signal is “earliest time” and the time indicated in the reception signal is older than the time indicated in the reference value 323 corresponding to the reception signal, the signal determining unit 310 produces the result of the signal determination process as “True”, and ends the processes of this flowchart.

Otherwise, the signal determining unit 310 proceeds to step S605.

(Step S605: Reception Interval Determination Process)

The signal determining unit 310 makes a determination as to “reception interval” as the determination item 322.

When the determination item 322 corresponding to the reception signal is “reception interval” and an interval between the time when the execution monitoring device 30 previously received a signal with the same name as the signal name corresponding to the reception signal and the time when the execution monitoring device 30 received the reception signal is equal to or longer than the interval indicated in the reference value 323 corresponding to the reception signal, the signal determining unit 310 produces the result of the signal determination process as “True”, and ends the processes of this flowchart.

Otherwise, the signal determining unit 310 proceeds to step S606.

(Step S606: Reception Sequence Determination Process)

The signal determining unit 310 makes a determination as to “reception sequence” as the determination item 322.

When the determination item 322 corresponding to the reception signal is “reception sequence” and the execution monitoring device 30 received signals in the sequence indicated in the reference value 323 corresponding to the reception signal, the signal determining unit 310 produces the result of the signal determination process as “True”, and ends the processes of this flowchart.

Otherwise, the signal determining unit 310 proceeds to step S607.

(Step S607: Consecutive Count Determination Process)

The signal determining unit 310 makes a determination as to “consecutive count” as the determination item 322.

When the determination item 322 corresponding to the reception signal is “consecutive count” and the execution monitoring device 30 received a signal with the same name as the reception signal consecutively with a count equal to or more than the count indicated in the reference value 323 corresponding to the reception signal, the signal determining unit 310 produces the result of the signal determination process as “True”, and ends the processes of this flowchart.

Otherwise, the signal determining unit 310 produces the result of the signal determination process as “False”, and ends the processes of this flowchart.

### Description of Effects of Embodiment 2

As has been described above, according to the present embodiment, the signal determining unit 310 determines whether to store the signal received by the execution monitoring device 30 by following the storage standard 321, and causes only the signal satisfying the storage standard 321 to be stored in the temporary buffer unit 221. Here, the storage standard 321 may correspond to a signal required for monitoring specification determination. Thus, the execution monitoring device 30 can cause only the signal required for monitoring specification determination to be stored in the temporary buffer unit 221.

Therefore, the execution monitoring device 30 according to the present embodiment allows the buffer size of the temporary buffer unit 221 to be decreased.

***Other Structures***

### Modification Example 2

The signal determining unit 310 may apply a plurality of determination items 322 to one reception signal.

In the present modification example, as a specific example, when the reception signal simultaneously satisfies the plurality of determination items 322, the signal determining unit 310 stores the reception signal in the temporary buffer unit 221. Note in the present modification example that data corresponding to each of the plurality of determination items 322 has been registered in the reference value 323.

### Modification Example 3

The execution monitoring device 30 may have a structure similar to that of the Modification Example 1.

### Other Embodiments

Any component in the above-described embodiments can be modified, or any component can be omitted in the embodiments.

Also, the embodiments are not limited to those described in Embodiments 1 and 2 and can be variously changed as required.

Note that in the description of the embodiments and the drawings, the same or corresponding components are provided with the same reference numeral. Description of the components provided with the same reference numeral is omitted or simplified as appropriate.

### REFERENCE SIGNS LIST

10: microcomputer; 20, 30: execution monitoring device; 101: CPU; 102: ROM; 103: RAM; 104: communication interface; 201: preprocessing unit; 202: next calculation specification determining unit; 203: invariant specification determining unit; 204: real-time specification determining unit; 205: expiration managing unit; 206: change time calculating unit; 207: output unit; 208: anomaly output unit; 221: temporary buffer unit; 222: monitoring specification storage unit; 223: calculation target storage unit; 224: determination result storage unit; 225: time-series data storage unit; 226: change time storage unit; 227: change time table storage unit; 228: anomaly process policy storage unit; 229: dependency relation storage unit; 310: signal determining unit; 320: storage standard storage unit; 321: storage standard; 322: determination item; 323: reference value.

1. An execution monitoring device, storing time-series data, comprising:
processing circuitry:
to determine whether the time-series data stored in the execution monitoring device satisfies a real-time specification, which is part of constraints included in a monitoring specification for electronic device runtime monitoring and is a constraint using a real time, and to update a determination result, which is a result of determining whether to satisfy the real-time specification,
to calculate, for each said real-time specification, a change time when the determination result of the real-time specification changes, and
to determine, if a current time is at or after the change time, that the real-time specification corresponding to the change time should be determined, wherein
the processing circuitry causes the determination result to be stored in a memory area reserved before determining whether the time-series data stored in the execution monitoring device satisfies the real-time specification and determines the real-time specification determined by the processing circuitry to be determined.

2. The execution monitoring device according to claim 1, wherein
the processing circuitry specifies, if the determination result of the real-time specification has been changed, a sub-specification that depends on the determination result of the real-time specification with the determination result changed and is part of the constraints included in the monitoring specification, and
the processing circuitry determines the real-time specification in the sub-specification specified by the processing circuitry.

3. The execution monitoring device according to claim 2, wherein
the processing circuitry specifies, if the determination result of the real-time specification has been changed, the sub-specification that depends on the determination result of the real-time specification based on a Rete network corresponding to the monitoring specification.

4. The execution monitoring device according to claim 1, wherein
the execution monitoring device stores a process policy if the execution monitoring device does not store all pieces of said time-series data for use by the processing circuitry in determining the real-time specification, and
if the execution monitoring device does not store all pieces of said time-series data for use in determining the real-time specification, the processing circuitry performs process by following the process policy, the process policy being stored in the execution monitoring device and corresponding to the real-time specification.

5. The execution monitoring device according to claim 1, wherein
the execution monitoring device stores a relationship between the monitoring specification and the real-time specification, and
the processing circuitry specifies, if the execution monitoring device does not store all pieces of said time-series data for use in determining the real-time specification, the monitoring specification corresponding to the real-time specification with reference to the relationship and outputs information about the monitoring specification.

6. An execution monitoring device, storing time-series data, comprising:
processing circuitry:
the execution monitoring device stores time-series data,
to determine whether the time-series data stored in the execution monitoring device satisfies a real-time specification, which is part of constraints included in a monitoring specification for electronic device runtime monitoring and is a constraint using a real time, and to update a determination result, which is a result of determining whether to satisfy the real-time specification, and
to specify, if the determination result of the real-time specification has been changed, a sub-specification that depends on the determination result of the real-time specification with the determination result changed and is part of the constraints included in the monitoring specification, wherein
the processing circuitry causes the determination result to be stored in a memory area reserved before determining whether the time-series data stored in the execution monitoring device satisfies the real-time specification and determines the real-time specification in the sub-specification specified by the processing circuitry.

7. An execution monitoring device, storing time-series data, comprising:
processing circuitry:
to determine whether the time-series data stored in the execution monitoring device satisfies a real-time specification, which is part of constraints included in a monitoring specification for electronic device runtime monitoring and is a constraint using a real time, and to update a determination result, which is a result of determining whether to satisfy the real-time specification, and
to store a process policy if the execution monitoring device does not store all pieces of said time-series data for use by the processing circuitry in determining the real-time specification, wherein
the processing circuitry causes the determination result to be stored in a memory area reserved before determining whether the time-series data stored in the execution monitoring device satisfies the real-time specification and, if the execution monitoring device does not store all pieces of said time-series data for use in determining the real-time specification, performs process by following the process policy, the process policy being stored in the execution monitoring device and corresponding to the real-time specification.

8. An execution monitoring device, storing time-series data and a relationship between the monitoring specification and the real-time specification, comprising:
processing circuitry:
to determine whether the time-series data stored in the execution monitoring device satisfies a real-time specification, which is part of constraints included in a monitoring specification for electronic device runtime monitoring and is a constraint using a real time, and to update a determination result, which is a result of determining whether to satisfy the real-time specification, and
to specify, if the execution monitoring device does not store all pieces of said time-series data for use in determining the real-time specification, the monitoring specification corresponding to the real-time specification with reference to the relationship and to output information about the monitoring specification, wherein
the processing circuitry causes the determination result to be stored in a memory area reserved before determining whether the time-series data stored in the execution monitoring device satisfies the real-time specification.

9. An execution monitoring method comprising:
storing time-series data;
determining whether the time-series data stored satisfies a real-time specification, which is part of constraints included in a monitoring specification for electronic device runtime monitoring and is a constraint using a real time, and updating a determination result, which is a result of determining whether to satisfy the real-time specification;
calculating for each said real-time specification, a change time when the determination result of the real-time specification changes; and
determining if a current time is at or after the change time, the real-time specification corresponding to the change time should be determined; and
causing the determination result to be stored in a memory area reserved before determining whether the time-series data stored satisfies the real-time specification and determining the real-time specification determined to be determined.

10. An execution monitoring method comprising:
storing time-series data;
determining whether the time-series data stored satisfies a real-time specification, which is part of constraints included in a monitoring specification for electronic device runtime monitoring and is a constraint using a real time, and updating a determination result, which is a result of determining whether to satisfy the real-time specification;
specifying if the determination result of the real-time specification has been changed, a sub-specification that depends on the determination result of the real-time specification with the determination result changed and is part of the constraints included in the monitoring specification; and
causing the determination result to be stored in a memory area reserved before determining whether the time-series data stored satisfies the real-time specification and determining the real-time specification in the sub-specification specified.

11. An execution monitoring method comprising:
storing time-series data;
determining whether the time-series data stored satisfies a real-time specification, which is part of constraints included in a monitoring specification for electronic device runtime monitoring and is a constraint using a real time, and updating a determination result, which is a result of determining whether to satisfy the real-time specification;
storing a process policy if all pieces of said time-series data for use in determining the real-time specification are not stored; and
causing the determination result to be stored in a memory area reserved before determining whether the time-series data stored satisfies the real-time specification and, if all pieces of said time-series data for use in determining the real-time specification are not stored, performing process by following the process policy, the process policy being stored and corresponding to the real-time specification.

12. An execution monitoring method comprising:
storing time-series data;
determining whether the time-series data stored satisfies a real-time specification, which is part of constraints included in a monitoring specification for electronic device runtime monitoring and is a constraint using a real time, and updating a determination result, which is a result of determining whether to satisfy the real-time specification;
storing a relationship between the monitoring specification and the real-time specification;
specifying if all pieces of said time-series data for use in determining the real-time specification are not stored, the monitoring specification corresponding to the real-time specification with reference to the relationship and outputting information about the monitoring specification; and
causing the determination result to be stored in a memory area reserved before determining whether the time-series data stored satisfies the real-time specification.

13. An execution monitoring device, storing time-series data and a storage standard for use in determining whether to store a signal corresponding to the time-series data and received by the execution monitoring device as a reception signal in the execution monitoring device, comprising:
processing circuitry:
to determine whether the time-series data stored in the execution monitoring device satisfies a real-time specification, which is part of constraints included in a monitoring specification for electronic device runtime monitoring and is a constraint using a real time, and to update a determination result, which is a result of determining whether to satisfy the real-time specification, wherein
the processing circuitry causes the determination result to be stored in a memory area reserved before determining whether the time-series data stored in the execution monitoring device satisfies the real-time specification, and
the processing circuitry determines whether the reception signal satisfies the storage standard and causes the reception signal to be stored in the execution monitoring device when the reception signal satisfies the storage standard.

14. The execution monitoring device according to claim 13, wherein
the processing circuitry calculates, for each said real-time specification, a change time when the determination result of the real-time specification changes,
the processing circuitry determines, if a current time is at or after the change time, that the real-time specification corresponding to the change time should be determined, and
the processing circuitry determines the real-time specification determined by the processing circuitry to be determined.

15. The execution monitoring device according to claim 13, wherein
the processing circuitry specifies, if the determination result of the real-time specification has been changed, a sub-specification that depends on the determination result of the real-time specification with the determination result changed and is part of the constraints included in the monitoring specification, and
the processing circuitry determines the real-time specification in the sub-specification specified by the processing circuitry.

16. The execution monitoring device according to claim 15, wherein
the processing circuitry specifies, if the determination result of the real-time specification has been changed, the sub-specification that depends on the determination result of the real-time specification based on a Rete network corresponding to the monitoring specification.

17. The execution monitoring device according to claim 13, wherein
the processing circuitry stores a process policy if all pieces of said time-series data for use by the processing circuitry in determining the real-time specification are not stored, and
if all pieces of said time-series data for use in determining the real-time specification are not stored, the processing circuitry performs process by following the process policy, the process policy being stored in the execution monitoring device and corresponding to the real-time specification.

18. The execution monitoring device according to claim 13, wherein
the execution monitoring device stores a relationship between the monitoring specification and the real-time specification, and
the processing circuitry specifies, if all pieces of said time-series data for use in determining the real-time specification are not stored, the monitoring specification corresponding to the real-time specification with reference to the relationship and outputs information about the monitoring specification.

19. The execution monitoring device according to claim 13, wherein
the reception signal includes a signal name indicating a name of the reception signal,
the storage standard includes a determination item indicating a viewpoint for the processing circuitry to determine the reception signal and a reference value corresponding to the determination item and for use by the processing circuitry in determining the reception signal,
the determination item and the reference value corresponds to the signal name, and
the processing circuitry determines the reception signal by using the determination item and the reference value.

20. An execution monitoring device, storing time-series data and a storage standard for use in determining whether to store a signal corresponding to the time-series data and received by the execution monitoring device as a reception signal in the execution monitoring device, comprising:
processing circuitry:
to determine whether the time-series data stored in the time-series data storage unit satisfies a real-time specification, which is part of constraints included in a monitoring specification for electronic device runtime monitoring and is a constraint using a real time, and to update a determination result, which is a result of determining whether to satisfy the real-time specification,
to calculate, for each said real-time specification, a change time when the determination result of the real-time specification changes, and
to determine, if a current time is at or after the change time, that the real-time specification corresponding to the change time should be determined, wherein
the processing circuitry causes the determination result to be stored in a memory area reserved before determining whether the time-series data stored in the execution monitoring device satisfies the real-time specification and determines the real-time specification determined by the processing circuitry to be determined, and
the processing circuitry determines whether the reception signal satisfies the storage standard and causes the reception signal to be stored in the execution monitoring device when the reception signal satisfies the storage standard.

21. The execution monitoring device according to claim 20, wherein
the reception signal includes a signal name indicating a name of the reception signal,
the storage standard includes a determination item indicating a viewpoint for the processing circuitry to determine the reception signal and a reference value corresponding to the determination item and for use by the processing circuitry in determining the reception signal,
the determination item and the reference value corresponds to the signal name, and
the processing circuitry determines the reception signal by using the determination item and the reference value.

22. An execution monitoring method, by an execution monitoring device, comprising:
storing time-series data;
determining whether the time-series data stored satisfies a real-time specification, which is part of constraints included in a monitoring specification for electronic device runtime monitoring and is a constraint using a real time, and updating a determination result, which is a result of determining whether to satisfy the real-time specification;
storing a storage standard for use in determining whether to store a signal corresponding to the time-series data and received by the execution monitoring device as a reception signal in the execution monitoring device;
determining whether the reception signal satisfies the storage standard and to cause the reception signal to be stored when the reception signal satisfies the storage standard; and
causing the determination result to be stored in a memory area reserved before determining whether the time-series data stored in the execution monitoring device satisfies the real-time specification.
